(19) United States
(12) Patent Application Publication
(10) Pub. No.: US 2021/0021407 A1
(43) Pub. Date: Jan. 21, 2021

(54) APPARATUS AND METHODS FOR BLOCKCHAIN-BASED VERIFICATION

(71) Applicant: CHARTER COMMUNICATIONS OPERATING, LLC, St. Louis, MO (US)

(72) Inventors: Srilal M. Weerasinghe, St. Louis, MO (US); Vipul Patel, Great Falls, VA (US); Basil Badawiyeh, Parker, CO (US); David Agranoff, St. Louis, MO (US)

(21) Appl. No.: 16/514,837

(22) Filed: Jul. 17, 2019

(51) Int. Cl. H04L 9/06; H04L 9/00; H04L 9/32; G06F 16/78; G06N 20/00; G06F 9/455

(52) U.S. Cl. CPC H04L 9/0643; H04L 9/006; H04L 9/3218; H04L 2209/38; G06N 20/00; G06F 9/45558; G06F 16/78

(57) ABSTRACT

Apparatus and methods for utilizing a blockchain-based mechanism to verify one or more events within a content distribution network, such as a cable, satellite, of HFC network. In some embodiments, the events relate to a display of alternate or secondary content (e.g., advertising content) distributed across a plurality of content networks carried by the content distribution network. A plurality of data (including records and verification data) are collected based on the occurrence (or failure) of the event, and subsequently processed to produce hash values. The hash values can be implemented to form blocks and chains (i.e., a blockchain), thereby validating the events within each block. The hash values also serve as sufficient proof of the event and hence, the content distributor is relieved of having to report voluminous data to third party entities they are contracted therewith. The hash values also serve to protect the privacy of customers by masking sensitive or propriety information relating thereto.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present disclosure relates generally to the field of digital data (e.g., text, video, and/or audio) delivery over one or more networks, such as content delivery networks and the Internet. More particularly, the present disclosure relates in one exemplary aspect to apparatus and methods for blockchain-based verification of certain events (e.g., alternate content switching (ACS) and dynamic secondary content (e.g., advertising, promotions, etc.) events) within a managed content distribution network (such as a cable, satellite, of hybrid fiber/co-axial (HFC) distribution network) or other network environment.

### 2. Description of Related Technology

Blockchain technology may feasibly be applied to any number of different applications and use cases. In the exemplary context of digital television (TV) advertising, blockchain applications have so far been limited to supply chain management. This limitation is understandable given the distributed ledger framework for recording transactions associated with blockchain. However, today's digital media advertising landscape is a complex eco-system with multiple intermediaries between advertisers and publishers, and solutions are needed in other areas of digital TV advertising. For example, increased transparency in the advertisement buying process is desired, as transaction mark-ups at each stage are somewhat opaque (and such opacity has been a source of concern). The issues in digital TV advertising and alternate content switching, including those relating to transparency, are discussed in detail below.

### Alternate Content Switching (ACS)

In a traditional content delivery system, video content may be distributed to a user's or subscriber's device, which is associated to a certain geographic area (e.g., a ZIP code or other designated region). There are various content delivery systems, such as but not limited to, subscriber systems, satellite systems, direct broadcast satellite (DBS) and cable television (CATV) systems. Under certain contractual provisions, specific content may be “blacked out” in certain geographic areas. For example, a sports event may be restricted to areas outside of the local market for ticket sales to the live event. Accordingly, many content delivery systems provide for geographic areas to be selectively blacked out for specific video content.

Additionally, with the advent of web-based digital TV/media, a new form of blackout events is now utilized; in particular, rights restrictions for content distribution on the web. That is, under certain contractual provisions, particularly in mobile content delivery systems, specific content may be “blacked out” for certain devices, operating systems, etc. Some examples of these ACS policies might include: (i) Golden Globe awards viewership to be limited to in-home devices only, (ii) an old black-and-white movie may not yet have rights cleared to be viewed on tablet devices, or (iii) a 4K movie may only be shown on a certain Android O/S or iOS due to version incompatibilities. In each case, the viewer is precluded from watching the scheduled program, and would be directed to a static image (“slate”) or to another TV channel (alternate content).

In the event that certain content (e.g., TV broadcast) is blacked out, the content delivery system provides alternative content to a subscriber during the blacked out event. For example, in one typical scenario, a CATV operator manually switches to another available signal for the blacked out event. As another example, a program provider of the blacked out event provides alternative content from another satellite or content feed during the blackout. In a typical CATV system, an operator sends instructions to the headend site of the CATV system to switch to another QAM (carrying different program content), or connect another satellite receiver, or retune the original satellite receiver to the alternate satellite feed during the blackout. Following the blackout, the original QAM may be retuned, or the satellite receiver may be re-connected, or manually tuned back to the primary satellite feed.

In addition to such manual switching arrangements, automatic switching or retiming of (e.g., satellite) receivers during a blackout make use of a remotely re-tunable receiver, which includes the capability to retune groups of subscribers to different feeds during (and after) a blackout of video content. To achieve flexible control over program blackouts in the exemplary satellite context, a receiver retune command message is selectively sent to desired groups of descramblers at CATV satellite downlinks. The retune command message identifies (in a typical implementation) an alternate satellite feed, and a time for which the satellite receiver is to tune to the alternate satellite feed. The receiver stores the retune command, and at the appropriate time retunes the satellite receiver to the identified alternate feed.

In a traditional mobile content delivery system, a mobile device communicates a request for specific content to a network entity (such as e.g., the network headend). The headend requests geographic coordinate location data from the mobile device, or uses global positioning satellites of the mobile device to determine a geographic coordinate point, or the headend uses the mobile device's IP address location. When the geographic coordinate data is available/determined, the headend determines whether the mobile device is in the geographic area to be selectively blacked out for the specific content. If the mobile device is in the selectively blacked out area, then the mobile content delivery system does not send the requested specific content. Alternatively, in the event that specific content is to be blacked out for, e.g., certain devices or operating systems, the headend may request other identifiers, such as a management interface IP address, a media access control address (MAC), IEMI, or other identifier.

Further, both traditional and mobile content delivery systems (especially in the advent of web-based digital TV/media) face new challenges with respect to auditing such ACS events. A major impetus for new solutions lies with the recent video auditing requirements of the SCTE 224 standard (see AMERICAN NATIONAL STANDARD—ANSI/SCTE 224 2018r1—“Event Scheduling and Notification Interface (ESNI),” 2018, incorporated herein by reference in its entirety).

SCTE 224 expands on previous standards and enables content distribution based on attributes such as device type and geographic location and numerous other characteristics. Audience-facing electronic program guides (EPGs) are also provided for, so as to inter alia, set accurate expectations with viewers as to what's going to be available, when, and to whom.

Additionally, SCTE 224 provides a framework of extensible markup language (XML) messages that enables detailed descriptions of audience characteristics, and viewing policies associated with each audience. Also, content channels (Media) and individual events (MediaPoints) are described and enable start and end times (MatchTime) or in-band signaling (MatchSignal) information, thereby facilitating metadata association.

As such, the new SCTE 224 standard offers rich capabilities to support a wide variety of alternate content and advertising scenarios. However, as the program sources introduce new functionalities, the content distributors are required to support them.

Additionally, the content distributors are required to report back the ACS compliance results to content providers and/or send proof of ACS events (i.e. ACS verification data) to the program source post-event. Such reporting requires the content disributor to send volumes of sensitive customer data back to each program source. Disseminating a large number of customer device data to third parties raises, among others, privacy concerns. Although de-anonymizing the data (e.g., cryptographic “one-way” hashing) is one option to address such privacy concerns, it is also susceptible to re-identification, especially with how quickly modern computers can compute hashes.

Moreover, it is also known in the industry that the validation of alternate content switching in IP streaming is a formidable challenge. Specifically, in contrast to on-demand and broadcast content, with Internet data and OTT (over-the-top) services, there is no IRD or vIRD from which data relating numerous devices (e.g., those within a zip code or service area) can be sampled. That is, for on-demand and broadcast content, the verification data is much simpler due to the use of IRDs or vIRDs (as the audience segments are geographical-based (a collection of zip codes served by an IRD/virtual-IRD)). Therefore, in such IRD/vIRD cases, the reporting need not be granular to the individual subscriber level.

### Advertisement Fraud

In managed content distribution networks (such as e.g., cable television, HFCu, or satellite networks), advertisements are usually interspersed within a given broadcasted or delivered program. In this manner, every user premises device (e.g., a subscriber's settop box or the like) in a local service area that is currently tuned to the same program channel will receive the same advertisements at approximately the same time and in the same order.

Advertisements or other “secondary content” (including, without limitation, promotions or “info-mercials”, commercials, telescoping information/advertisements, and short segments) that are ultimately viewed by subscribers or other content consumers in such networks can be controlled in several ways. Generally, two categories or subdivisions of these techniques exist: (i) national- or high-level insertion, and (ii) local- or low-level insertion.

Under national level insertion, national networks (such as NBC, ABC, etc.) are responsible for determining the advertisements or promotions that are resident in a given program or other primary content stream or discrete content element. The pre-configured stream is delivered to the network operator (e.g., MSO), and the MSO merely then delivers the stream (content and advertisements) to the relevant subscribers over their network.

Under local-level insertion, the MSO (and even broadcast affiliates) can insert locally-generated advertisements or commercials and other such segments into remotely distributed regional programs before they are delivered to the network subscribers.

Secondary content insertion may comprise a major source of revenue for Internet website operators (e.g., YouTube™), commercial television/content distributors, and for the network operator. For example, where the secondary content comprises advertisements, it may be a main source of income for national television broadcasters and their local over-the-air affiliates. Cable, satellite, and other content distribution networks, as well as Internet content providers, also derive income from the sale of advertising time.

In order for an advertiser to maximize the return on their advertising investment, advertisers, promoters or other entities need to be assured that the secondary content for which they are paying to have displayed are actually being consumed by a client device at the direction of a human who is viewing the secondary content and associated primary or program content. An advertisement accounting service (also referred to as an Advertisement Decisioning Service (ADS) in some contexts) is used within content distribution network infrastructure to determine which individual ones of the secondary (or other) content will be placed in each of the advertisement placement opportunities prior to the delivery of content to the client device. The ADS may include, for example, an ad server or the like. In addition, the ADS is used to keep track of other data, such as e.g., the number of times an individual one of the secondary content is requested by the client device. Somewhat analogous to an Internet advertisement “click through,” this information is used to invoice the advertiser who pays the advertisement distributor based upon the number of advertisements served.

However, most of the methods of displaying secondary content are susceptible to computer-automated programs (e.g., “bots”) created by malicious agents. Theses computer-automated programs “spoof” or trick the ADS by communicating data or messaging to the ADS that an advertisement is being requested, when in fact there are no legitimate viewers consuming the advertising. This scenario constitutes one type of “advertisement viewing fraud.” Extant advertising management systems such as the aforementioned ADS do not actually verify that the request for the advertisement is in fact legitimate, but rather merely log such requests and presume that delivery actually occurs, and such delivery is to a legitimate consumer.

For example, a typical art management system receives a request from a client (e.g., subscriber device) for a manifest file, which contains information such as URLs (universal resource locators) for primary and secondary content elements (e.g., video content and advertisements, respectively). The manifest file request is directed to an entity which coordinates obtaining information about the advertisements that should be inserted into the video stream via the manifest file. The manifest file is then assembled, including a first “accounting” URL for each unique request, and delivered to the requesting client. The client then uses the manifest file to obtain the manifested primary (e.g., video/audio) content. When an advertising break occurs within the primary content, a first advertising-related URL is utilized to notify a network entity that an advertisement is about to be delivered, and presumably viewed by the video rendering client. The video client then requests the video chunks representing the advertisement from the network using the manifest file URLs pertaining to the advertisement. Unfortunately, a rogue client or surreptitious “bot” can merely perform the aforementioned notification of the network entity one or more times to artificially “trick” the network entity/management system into believing that advertisements are being requested by a valid video client (and presumably being viewed by a human).

One principal motivation of the malicious agent in advertisement viewing fraud scenarios is to undermine confidence in the integrity and accounting practices of the distributor, who is paid to distribute the secondary content and associated primary content. This is somewhat similar to “click fraud” scenarios, whereby a “click bot” imitates a legitimate user of a web browser clicking on an ad, thereby generating a charge-per-click without having actual interest in the target of the advertisement's link. However, in click fraud scenarios, the malicious agent is typically a competitor who seeks to beat down the advertiser's website and advertising account. Under any scenario, such malicious activity is highly detrimental and undesirable.

The advertisement technology industry is responding to advertisement fraud on two fronts: (i) the enterprise sector, and (ii) industrial consortiums. In the enterprise sector, new initiatives are on the rise, such as applying blockchain technology to improve transparency (e.g., IBM/MediaOcean). In parallel, the industry consortiums are developing new standards to combat advertisement fraud. For example, the Interactive Advertising Bureau (IAB) has just published its VAST 4.1 (Nov 2018) standard (IAB, 2018) with enhancements for ad verification.

Thus, in both of the aforementioned use cases (i.e., ACS and advertisement fraud), the challenge is to provide valid proof that the alternate or secondary content was displayed (or switched) as contracted. The reporting of such valid proof also lends itself to efficiency and transparency issues, as voluminous data (which may contain proprietary or protected customer information) needs to be reported in the current systems, particularly with respect to IP streaming and OTT services.

Accordingly, improved apparatus and methods are needed to address the foregoing, including verifying certain “events” (e.g., alternate content switching and advertisement viewership). Such apparatus and methods could in addition, inter alia, ensure accurate, efficient, and transparent reporting of the consumption of an advertisement or other secondary or alternate content element by one or more users, while maintaining the users' privacy. Ideally, these apparatus and methods could be readily integrated in a wide variety of platforms, including IP streaming and OTT delivery systems.

### SUMMARY

The present disclosure addresses the foregoing needs by disclosing, inter alia, apparatus and methods for blockchain-based verification of events (including e.g., alternate content switching and dynamic secondary content display events).

In one aspect of the disclosure, a computerized method for verifying an event in a content delivery network is disclosed. In one embodiment, the computerized method includes: receiving first data; applying the first data to one or more computerized devices, the applying configured to cause the event; based on a verification of an occurrence of the event, receiving at least one data structure associated with the event and verification data relating to the verification; causing generation of a cryptographic hash of the at least data structure and verification data; causing application of the cryptographic hash to a ledger; and causing storage of the ledger in a database.

In one variant, the first data comprises alternate content switching (ACS) data, and the event comprises an ACS-related event.

In a second aspect, a non-transitory computer readable apparatus is disclosed. In one embodiment, the apparatus includes a storage medium, the storage medium comprising at least one computer program having a plurality of instructions, the plurality of instructions configured to, when executed, cause verification of digital secondary content servicing in a content delivery network using at least a computerized method. In one implementation, the method includes: receiving digital secondary content from one or more sources of the content delivery network; causing display of the digital secondary content on one or more computerized devices; receiving a data structure associated with the display event; causing generation of a cryptographic hash, the cryptographic hash comprising a hash of at least the data structure; causing formation of a blockchain data structure via use of the cryptographic hash; and causing storage of the blockchain data structure in a database.

In one variant, the receiving of the digital secondary content comprises receiving an advertisement, and the one or more sources comprise one or more respective advertisers.

In another variant, the causing of the display of the digital secondary content on the one or more computerized devices comprises causing display of the digital secondary content on at least one of: (i) customer premises equipment (CPE), (ii) one or more computerized mobile devices, (iii) one or more computerized test devices, the one or more computerized test devices located in a video operations data center, and (iv) a virtual machine environment.

In yet another variant, the receiving of the data structure associated with the display event comprises receiving a record of a display of only a portion of the digital secondary content, the portion determined based on use of a percentile beacon.

In a further variant, the method further includes: receiving verification data from the one or more computerized devices, the verification data indicating a verification of the display event; and transmitting the data structure associated with the display event and the verification data to a blockchain server apparatus together in a composite data stream. The generation, the formation, and the storage are each performed automatically by the blockchain server based on receipt of the composite data stream; and the cryptographic hash comprises a hash of at least the data structure and the verification data.

In a further aspect, a distributed network architecture for verification of one or more events in a network is disclosed. In one embodiment, the distributed network architecture includes: a plurality of computerized client devices, the plurality of computerized client devices in data communication with one or more respective intermediary entities. In one variant, the one or more intermediary entities are (i) in data communication with one or more respective blockchain server apparatus, and (ii) configured to transmit data relating one or more events to the one or more blockchain server apparatus based on an occurrence of the one or more events or on verification of the occurrence of the one or more events; and the one or more blockchain server apparatus are configured to automatically perform a blockchain process, the blockchain process comprising (i) one or more hash functions performed on the data relating the one or more events, and (ii) validation of the one or more events.

In another aspect, a network server apparats is disclosed.

In yet another aspect, a blockchain server apparatus is disclosed.

In still a further aspect, a record format or architecture is disclosed. In one variant, the format or architecture is used for ACS data.

In yet another aspect, an integrated circuit (IC) is disclosed. In one embodiment, the IC is configured to form hashes from verification data, and utilize the hashes to generate blockchain elements.

These and other aspects of the disclosure shall become apparent when considered in light of the detailed description provided herein.

### BRIEF DESCRIPTION OF THE DRAWINGS

FIG. 1 is a functional block diagram illustrating an exemplary hybrid fiber coax (HFC) cable network configuration useful with various aspects of the present disclosure.

FIG. 1a is a functional block diagram illustrating one exemplary HFC cable network headend configuration useful with various aspects of the present disclosure.

FIG. 1b is a functional block diagram illustrating one exemplary embodiment of a local service node configuration useful with various aspects of the present disclosure.

FIG. 1c is a functional block diagram illustrating a second exemplary packetized content delivery network architecture useful with various aspects of the present disclosure.

FIG. 2 is a functional block diagram illustrating one exemplary embodiment of a blockchain-based verification architecture according to the present disclosure.

FIG. 2a is a functional block diagram illustrating an exemplary network server configuration according to the present disclosure.

FIG. 2b is a functional block diagram illustrating an exemplary blockchain server configuration according to the present disclosure.

FIG. 3 is a functional block diagram illustrating one exemplary embodiment of a distributed architecture according to the present disclosure.

FIG. 4 is an exemplary ACS data record according to the present disclosure.

FIG. 5 is an exemplary hash tree according to the present disclosure.

FIG. 6 is an exemplary blockchain structure according to the present disclosure.

FIG. 7 is a logical flow diagram illustrating an exemplary embodiment of a computerized method for verifying ACS event data according to the present disclosure.

FIG. 7a is a graphical representation of one exemplary implementation of the method of FIG. 7.

FIG. 8 is a logical flow diagram illustrating an exemplary embodiment of a computerized method for verifying secondary content display events according to the present disclosure.

FIG. 8a is a graphical representation of one exemplary implementation of the method of FIG. 8.

All figures © Copyright 2019 Charter Communications Operating, LLC. All rights reserved.

### DETAILED DESCRIPTION

Reference is now made to the drawings wherein like numerals refer to like parts throughout.

As used herein, the term “advertisement” and similar forms refers without limitation to any audio, visual, or promotion, message, or communication, whether for-profit or otherwise, that is perceptible by a human. Examples of advertisements include so-called “bumper” advertisements (advertisements inserted before or after a client requested program), “pause” advertisements (presented when a client sends a pause control command to a video server or the like), or additional and replacement advertisements.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java X1et™ that runs within the JavaTV™ environment.

As used herein the term “browser” refers to any computer program, application or module which provides network access capability including, without limitation, Internet browsers adapted for accessing one or more websites or URLs over the Internet, as well as any “user agent” including those adapted for visual, aural, or tactile communications.

As used herein, the terms “client device” and “end user device” include, but are not limited to, set-top boxes (e.g., DSTBs), gateways, APs, routers, “smart” televisions, gateways, modems, personal computers (PCs), and minicomputers, whether desktop, laptop, or otherwise, and mobile devices such as handheld computers, personal media devices (PMIDs), tablets, and smartphones.

As used herein, the term “codec” refers to an video, audio, or other data coding and/or decoding algorithm, process or apparatus including, without limitation, those of the MPEG (e.g., MPEG-1, MPEG-2, MPEG-4, etc.), H.264, H.265/HEVC, Real (Real Video, etc.), AC-3 (audio), DiVX, XViD/ViDX, Windows Media Video (e.g., WMV 7, 8, 9, 10), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Python, Ruby, Binary Runtime Environment (e.g., BREW), and the like.

As used herein, the term “conditional access” refers to any access control scheme, whether implemented in hardware, software, or firmware (or combinations thereof), including without limitation members of the “Powerkey” family (Powerkey Book 2, Powerkey Book 3, etc.), NDS (including VideoGuard, mVideoGuard, etc.), ANSI/SCTE Standard 52 2003 (DVS-042), incorporated herein by reference in its entirety, and Motorola/General Instrument DigiCipher° family (DigiCipher II, etc.). These can be implemented using, for example, the so-called “CableCard” plug-in security module access technology, a downloadable CA system (DCAS), or otherwise.

The terms “Consumer Premises Equipment (CPE)” and “host device” refer without limitation to any type of electronic equipment located within a consumer's or user's premises and connected to or in communication with a network, and may include client devices or end-user devices. The term “host device” includes terminal devices that have access to digital television content via a satellite, cable, wireless or terrestrial network. The host device functionality may be integrated into a digital television (DTV) set.

As used herein, the term “database” refers generally to one or more tangible or virtual data storage locations, which may or may not be physically co-located with each other or other system components.

As used herein, the term “display” means any type of device adapted to display information, including without limitation CRTs, LCDs, TFTs, plasma displays, LEDs, incandescent and fluorescent devices. Display devices may also include less dynamic devices such as, for example, printers, e-ink devices, and the like.

As used herein, the term “DOCSIS” refers to any of the existing or planned variants of the Data Over Cable Services Interface Specification, including for example DOCSIS versions 1.0, 1.1, 2.0, 3.0, and 3.1 (including CCAP). DOCSIS (version 1.0) is a standard and protocol for internet access using a “digital” cable network.

As used herein, the term “headend” refers generally to a networked system controlled by an operator (e.g., an MSO or multiple systems operator) that distributes programming to MSO clientele using client devices. Such programming may include literally any information source/receiver including, inter alia, free-to-air TV channels, pay TV channels, interactive TV, and the Internet.

As used herein, the terms “Internet” and “internet” are used interchangeably to refer to inter-networks including, without limitation, the Internet.

As used herein, the terms “memory” or “memory device” may include any type of integrated circuit or other storage device adapted for storing digital data including, without limitation, ROM, PROM, EEPROM, DRAM, SDRAM, DDR/2 SDRAM, DDR/3 SDRAM, DDR/4 SDRAM, GDDRx, EDO/FPMS, FeRAM, ReRAM, RLDRAM, SRAM, “flash” memory (e.g., NAND/NOR), 3D memory, and PSRAM.

As used herein, the terms “microprocessor” and “digital processor” are meant generally to include all types of digital processing devices including, without limitation, digital signal processors (DSPs), reduced instruction set computers (RISC), general-purpose complex instruction set computing (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “modem” refers to any kind of modulation or demodulation process or apparatus including without limitation cable (e.g., DOCSIS compliant) modems, DSL modems, analog modems, and so forth.

As used herein, the terms “MSO” or “multiple systems operator” refer to a cable, satellite, or terrestrial network provider having infrastructure required to deliver services including programming and data over those mediums.

As used herein, the term “network content provider” refers generally and without limitation to any content service provider or content-providing logical “network” such as e.g.,

ABC, NBC, CBS, etc., regardless of delivery platform or underlying content distribution network infrastructure (see below).

As used herein, the terms “network” and “bearer network” (distinguished from “network content provider” supra) refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network interface” refers to any signal, data, or software interface with a component, network or process including, without limitation, those of the FireWire (e.g., FW400, FW800, etc.), USB (e.g., USB2, USB 3.0), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., LTE/LTE-A, 3GPP 5G NR, 3GPP2, UMTS), or IrDA families.

As used herein, the term “node” refers to any functional entity associated with a network, such as for example: CPE, edge device, server, gateway, router, Optical Line Terminal (OLT), Optical Network Unit (ONU), etc. whether physically discrete or distributed across multiple locations.

As used herein, the terms “personal media device” and “PMD” refer to, without limitation, any device, whether portable or otherwise, capable of storing and/or rendering media.

As used herein, the term “secondary content” refers without limitation to content other than primary programming content, such as e.g., advertisements, promotions, “telescoping” content, info-mercials, trailers, icons or animated overlays, etc. which may be presented either alone or in conjunction with the primary (or yet other) content.

As used herein, the term “server” refers to, without limitation, any computerized component, system or entity regardless of form which is adapted to provide data, files, applications, content, or other services to one or more other devices or entities on a computer network.

As used herein, the term “user interface” refers to, without limitation, any visual, graphical, tactile, audible, sensory, or other means of providing information to and/or receiving information from a user or other entity. A user interface may comprise, for example, a computer screen display, touch screen, speech recognition engine, text-to-speech (TTS) algorithm, and so forth.

As used herein, the term “Wi-Fi” refers to, without limitation, any of the variants of IEEE-Std. 802.11 or related standards including 802.11 a/b/g/n/s/v/ac or 802.11-2012, as well as so-called “Wi-Fi Direct”, each of the foregoing incorporated herein by reference in its entirety. As used herein, the term “wireless” means any wireless signal, data, communication, or other interface including without limitation Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, Zigbee, RFID/NFC, narrowband/FDMA, OFDM, PCS/DCS, LTE/LTE-A, 5G NR, analog cellular, CDPD, satellite systems, millimeter wave or microwave systems, acoustic, and infrared (i.e., IrDA).

### Overview

In one salient aspect, the present disclosure provides apparatus and methods for blockchain-based verification of certain “events,” such as alternate content switching (ACS) events and secondary content display events.

In one embodiment described herein, a managed content distribution network (e.g., cable television network) is configured to ensure accurate reporting of such events, including the integrity of data relating thereto, such that e.g., no event is reported twice. In one implementation, this is accomplished by collecting composite data relating to the event, including data relating to the validation of the event (e.g., audio, visual or textual proof of the event, such as a video capture), from the devices at which event occurred, or at least was supposed to occur. The composite data is transmitted to a blockchain server entity, which automatically performs a hierarchical hashing algorithm on the composite data in order to add the composite data in a link-listed form to a blockchain data structure. The automated cryptographic nature of the blockchain system of the present disclosure advantageously solves multiple core issues associated with auditing and reporting certain events, such as those relating to digital advertising and ACS events; namely: (i) ensuring sufficient independent verification of the events, (ii) maintaining privacy, and (iii) the amount of data necessary to be reported. More specifically, in current practice, when a content distributor is under a contractual agreement with a third party entity such as an advertiser or a ACS program source to cause a certain event, the third party entity does not want the content distributor to verify its own data. Therefore, in order for such events to be verified, the content distributor must report voluminous data relating to the event. Such reporting data may contain information about the users that is proprietary or protected by contractual agreements between the content distributor and the users, and further may place a significant burden on the content distributor or others.

The blockchain protocol of the present disclosure solves the foregoing issues because (i) even though the blockchain servers may be maintained by the content distributor, the blockchain protocol ensures automatic (and therefore independent) validation of the events, and (ii) the hashes of the events maintain the privacy of the users while serving as sufficient proof of the event. More specifically, the integrity of the data is maintained by automated cryptographic hashing of each block as well as tying each block to the prior block in the chain.

Moreover, the present disclosure provides, in one embodiment, a centralized database to store the blockchain ledger, and in another embodiment, an interface that advantageously allows multiple third party entities (e.g., program sources, advertisers, content providers), or proxies, to access the verified data as the ledger is updated.

### Detailed Description of Exemplary Embodiments

Exemplary embodiments of the apparatus and methods of the present disclosure are now described in detail. While these exemplary embodiments are described primarily in the context of mentioned managed hybrid fiber coax (HFC) cable architecture having a multiple systems operator (MSO), digital networking capability, IP delivery capability (including e.g., IP-packetized delivery via CMTS/DOCSIS, and/or so called “in band” delivery of IP content such as via an MPEG transport stream carrying IP-packetized content or OTT), and a plurality of client devices/CPE, the general principles and advantages of the disclosure may be extended to other types of networks and architectures that are configured to deliver digital media data (e.g., text, video, and/or audio, discrete content elements such as files, executables, etc.). Such other networks or architectures may be broadband, narrowband, wired or wireless, managed or unmanaged, hybridized between two or more topologies or delivery modalities, or otherwise. It will also be appreciated that while described generally in the context of a network providing service to a customer or consumer or end user (i.e., residential), the present disclosure may be readily adapted to other types of environments including, e.g., commercial/retail, or enterprise domain (e.g., businesses), and government/military applications. Myriad other applications are possible.

Also, while certain aspects are described primarily in the context of the well-known Internet Protocol (described in, inter alia, Internet Protocol DARPA Internet Program Protocol Specification, IETF RCF 791 (Sept. 1981) and Deering et al., Internet Protocol, Version 6 (Ipv6) Specification, IETF RFC 2460 (December 1998), each of which is incorporated herein by reference in its entirety), it will be appreciated that the present disclosure may utilize other types of protocols (and in fact bearer networks to include other internets and intranets) to implement the described functionality.

Other features and advantages of the present disclosure, including improvements to computerized technology, will immediately be recognized by persons of ordinary skill in the art with reference to the attached drawings and detailed description of exemplary embodiments as given below.

### Bearer Network

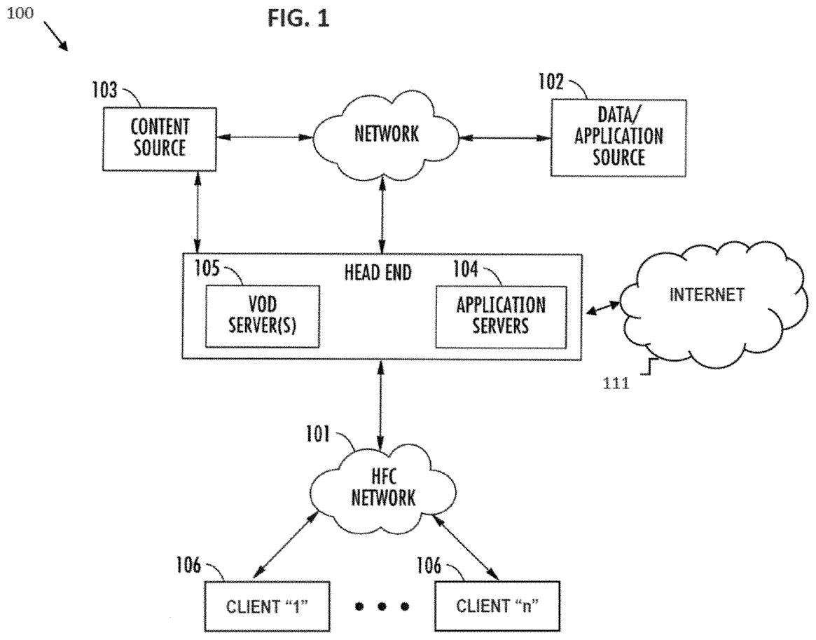

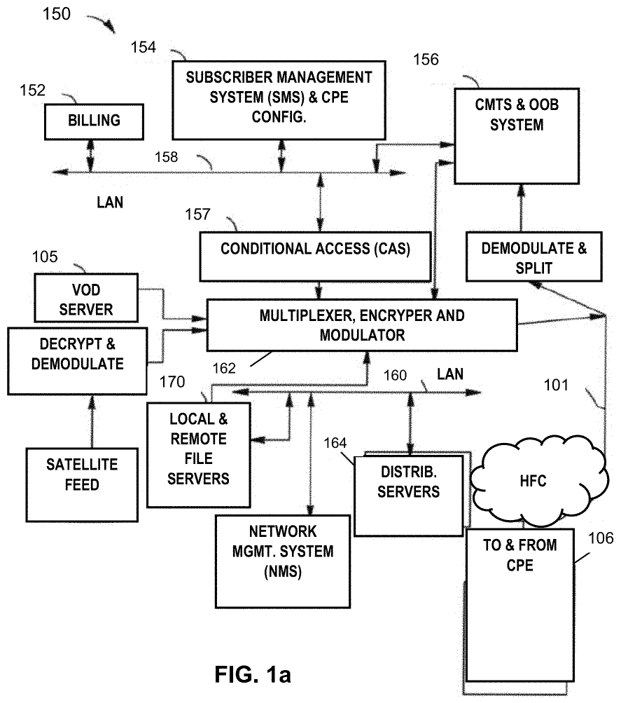

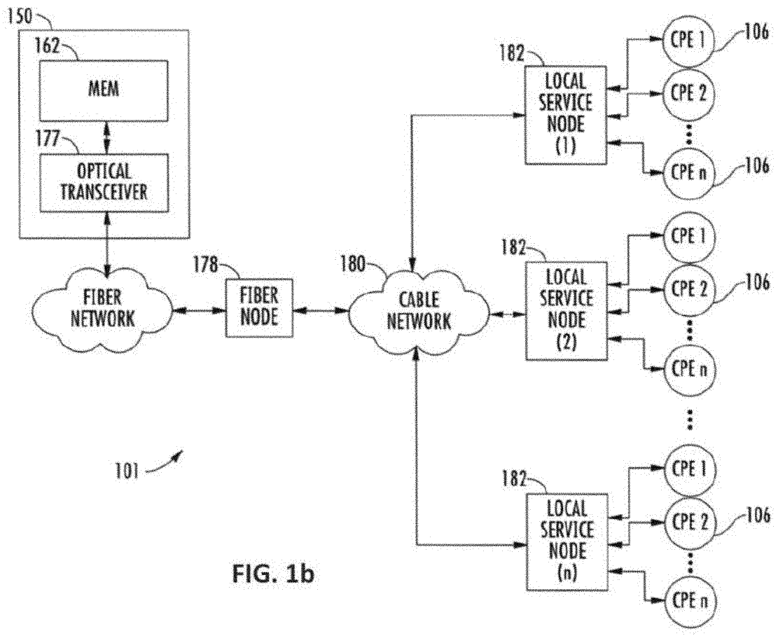

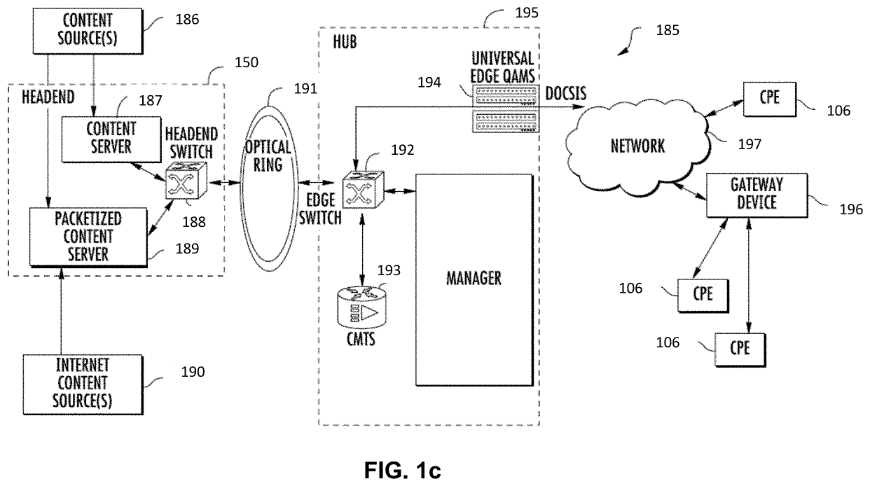

FIG. 1 illustrates a typical managed content delivery network configuration. The various components of the network 100 include (i) one or more data and application origination points 102; (ii) one or more content sources 103, (iii) one or more application distribution servers 104; (iv) one or more Video-On-Demand (VOD) servers 105, and (v) customer premises equipment (CPE) or client devices 106. The distribution server(s) 104, VOD servers 105 and CPE(s) 106 are connected via a bearer (e.g., HFC) network 101. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the present disclosure. For example, the headend architecture of FIG. 1a (described in greater detail below), or others, may be used.

The data/application origination point 102 comprises any medium that allows data and/or applications (such as a VOD-based or “Watch TV” application) to be transferred to a distribution server 104. This may include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill. The application distribution server 104 comprises a computer system where such applications enter the network system. Distribution servers are well known in the networking arts, and accordingly not described further herein.

The VOD server 105 comprises a computer system where on-demand content is received from one or more of the aforementioned data sources 102 and enter the network system. These servers may generate the content locally, or alternatively act as a gateway or intermediary from a distant source.

The VOD server 105 and application distribution servers 104 are a part of the headend architecture of the network 100. The headend 150 is connected to an internetwork (e.g., the Internet) 111.

Referring now to FIG. 1a, one exemplary embodiment of a headend architecture is described. As shown in FIG. 1a, the headend architecture 150 comprises typical headend components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the disclosure. It will also be appreciated that the headend configuration depicted in FIG. 1a is high-level, conceptual architecture, and that each MSO may have multiple headends deployed using custom architectures.

The exemplary architecture 150 of FIG. 1a further includes a conditional access system (CAS) 157 and a multiplexer-encrypter-modulator (MEM) 162 coupled to the HFC network 101 adapted to process or condition content for transmission over the network. The distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend, as previously described and sent to neighborhood hubs (FIG. 1b) via a variety of interposed network components.

Content (e.g., audio, video, data, files, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0, 2.0, 3.0 (and subsequent) specification provides for exemplary networking protocols both downstream and upstream, although the present disclosure is in no way limited to these approaches.

### “Packet-Optimized Networks”

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment of the disclosure, a “packet optimized” delivery network is used for carriage of the packet content (e.g., IPTV content). In one exemplary implementation of such a network, a 3GPP IMS (IP Multimedia Subsystem) network with common control plane and service delivery platform (SDP) is utilized, as described in co-pending U.S. Provisional Patent Application Ser. No. 61/256,903 filed Oct. 30, 2009 and entitled “METHODS AND APPARATUS FOR PACKETIZED CONTENT DELIVERY OVER A CONTENT DELIVERY NETWORK”, which is now published as U.S. Patent Application Publication No. 2011/0103374 of the same title filed on Apr. 21, 2010, each of which is incorporated herein by reference in its entirety. Such a network provides, inter alia, significant enhancements in terms of common control of different services, implementation and management of content delivery sessions according to unicast or multicast models, etc.; however, it is appreciated that the various features of the present disclosure are in no way limited to this or any of the other foregoing architectures.

FIG. 1c shows another exemplary network architecture optimized for the delivery of packetized content disclosure useful with the present disclosure. In addition to on-demand and broadcast content (e.g., video programming), the system of FIG. 1c may deliver Internet data services using the e.g., Internet protocol (IP).

The network 185 generally comprises a local headend 150 in communication with at least one hub 195 via an optical ring 191. The distribution hub 195 is able to provide content to various user devices, CPE 106, and gateway devices 196, via a network 197.

Various content sources 186 are used to provide content to a content server 187. For example, content may be received from a local, regional, or network content library as discussed in co-owned co-pending U.S. application Ser. No. 12/841,906 filed on Jul. 22, 2010 and entitled “APPARATUS AND METHODS FOR PACKETIZED CONTENT DELIVERY OVER A BANDWIDTH-EFFICIENT NETWORK”, which is incorporated herein by reference in its entirety. Alternatively, content may be received from linear analog or digital feeds, as well as third party content sources. Internet content sources 190 (such as e.g., a web server) provide Internet content to a packetized content server 189. Other IP content may also be received at the packetized content server 189, such as voice over IP (VoIP) and/or IPTV content. Content may also be received from subscriber and non-subscriber devices (e.g., a PC or smartphone-originated user made video). In one embodiment, the functionality of both the content server 187 and packetized content server 189 may be integrated into a single server entity.

A central media server located in the headend 150 may be used as an installed backup to the hub media servers as (i) the primary source for lower demand services, and (ii) as the source of the real time, centrally encoded programs with PVR (personal video recorder) capabilities. By distributing the servers to the hub stations 195 as shown in FIG. ld, the size of the fiber transport network associated with delivering VOD services from the central headend media server is advantageously reduced. Hence, each user has access to several server ports located on at least two servers. Multiple paths and channels are available for content and data distribution to each user, assuring high system reliability and enhanced asset availability. Substantial cost benefits are derived from the reduced need for a large content distribution network, and the reduced storage capacity requirements for hub servers (by virtue of the hub servers having to store and distribute less content).

It will also be recognized that a heterogeneous or mixed server approach may be utilized consistent with the disclosure. For example, one server configuration or architecture may be used for servicing cable, satellite, HFCu, etc. subscriber CPE-based session requests, while a different configuration or architecture may be used for servicing mobile client requests. Similarly, the content servers 187, 189 may either be single-purpose/dedicated (e.g., where a given server is dedicated only to servicing certain types of requests), or alternatively multi-purpose (e.g., where a given server is capable of servicing requests from different sources).

The network 185 of FIG. 1c may further include a legacy multiplexer/encrypter/modulator (MEM; not shown) coupled to the network 197 adapted to “condition” content for transmission over the network. In the present context, the content server 187 and packetized content server 189 may be coupled to the aforementioned LAN, thereby providing access to the MEM and network 197 via one or more file servers (not shown). The content server 187 and packetized content server 1006 are coupled via the LAN to a headend switching device 188 such as an 802.3z Gigabit Ethernet (or incipient “10G”) device. Video and audio content is multiplexed at the headend 150 and transmitted to the edge switch device 192 (which may also comprise an 802.3z Gigabit Ethernet device).

Individual CPEs 106 of the implementation of FIG. 1c may be configured to monitor the particular assigned RF channel (such as via a port or socket ID/address, or other such mechanism) for IP packets intended for the subscriber premises/address that they serve.

In the switched digital variant, the IP packets associated with Internet services are received by edge switch, and forwarded to the cable modem termination system (CMTS) 193. The CMTS examines the packets, and forwards packets intended for the local network to the edge switch. Other packets are in one variant discarded or routed to another component.

The edge switch forwards the packets receive from the CMTS to the QAM modulator, which transmits the packets on one or more physical (QAM-modulated RF) channels to the CPE. The IP packets are typically transmitted on RF channels that are different than the RF channels used for the broadcast video and audio programming, although this is not a requirement. As noted above, the CPE are each configured to monitor the particular assigned RF channel (such as via a port or socket ID/address, or other such mechanism) for IP packets intended for the subscriber premises/address that they serve.

In one embodiment, both IP data content and IP-packetized audio/video content is delivered to a user via one or more universal edge QAM devices 194. According to this embodiment, all of the content is delivered on DOCSIS channels, which are received by a premises gateway 196 (described subsequently herein) and distributed to one or more CPE 106 in communication therewith. Alternatively, the CPE 106 may be configured to receive IP content directly without need of the gateway or other intermediary. As a complementary or back-up mechanism, audio/video content may also be provided in downstream (in-band) channels as discussed above; i.e., via traditional “video” in-band QAMs. In this fashion, a co-enabled digital set top box (DSTB) or other CPE could readily tune to the new (in-band) RF video QAM in the event that their IP session over the DOCSIS QAM is for some reason interrupted. This may even be accomplished via appropriate logic within the CPE (e.g., autonomously, or based on signaling received from the headend or other upstream entity, or even at direction of a user in the premises; e.g., by selecting an appropriate DSTB or other CPE function).

In the embodiment illustrated in FIG. 1c, IP packetized content is provided to various user devices via the network 197. For example, content may be delivered to a gateway apparatus 196 which distributes content received thereat to one or more CPE 106 in communication with the apparatus 196.

In another variant, IP simulcast content and existing on-demand, voice, and broadcast content are all provided to the headend switch device 188 of FIG. lc. The headend switch 1008 then provides the content to the optical ring 191 for provision to one or more distribution hubs 195. IP simulcast content is in one exemplary implementation retrieved from a plurality of content sources at an IPTV server.

The IP-packet content is transmitted to subscriber devices via the universal edge QAM 194 and the edge network 197. The IP video (“simulcast”) content is presented to client devices capable of receiving content over the DOCSIS QAMs. For example, the aforementioned gateway device 196 (as well as an advanced CPE 106 such as an IP-enabled DSTB may receive the IP simulcast. Legacy CPE may receive content via the gateway device 196, or via an audio/video “back-up” MPEG transport stream as previously described.

In the illustrated embodiment, the gateway device 196 serves as a gateway to the IP content for other client devices (such as other CPE 106 and PMD). The gateway device 196 may communicate with one or more connected CPE 106, as well as utilize Wi-Fi capabilities (where so equipped) to communicate wirelessly to other devices. It will also be recognized that the present disclosure may be configured with one or more short-range wireless links such as Bluetooth for lower bandwidth applications (or PAN for greater bandwidth applications).

It is still further appreciated that the delivery of content may include delivery from an “off-net” distribution hub (not shown) to another network (not shown), not associated with the MSO. In this embodiment, a requesting device (such as CPE 106 or gateway 196, or user mobile device) may request content from a local headend 150 which is transferred over both MSO-maintained (“on-net”) and “off-net” networks, such as an interposed Wi-Fi access point (AP) with non-MSO broadband connection to the Internet, such as a Telco FiOS, 4G LTE/5G NR modem, or the like (and via which the serving MSO server at e.g., the headend 150 delivers content).

### Exemplary Blockchain-Based Verification Architecture

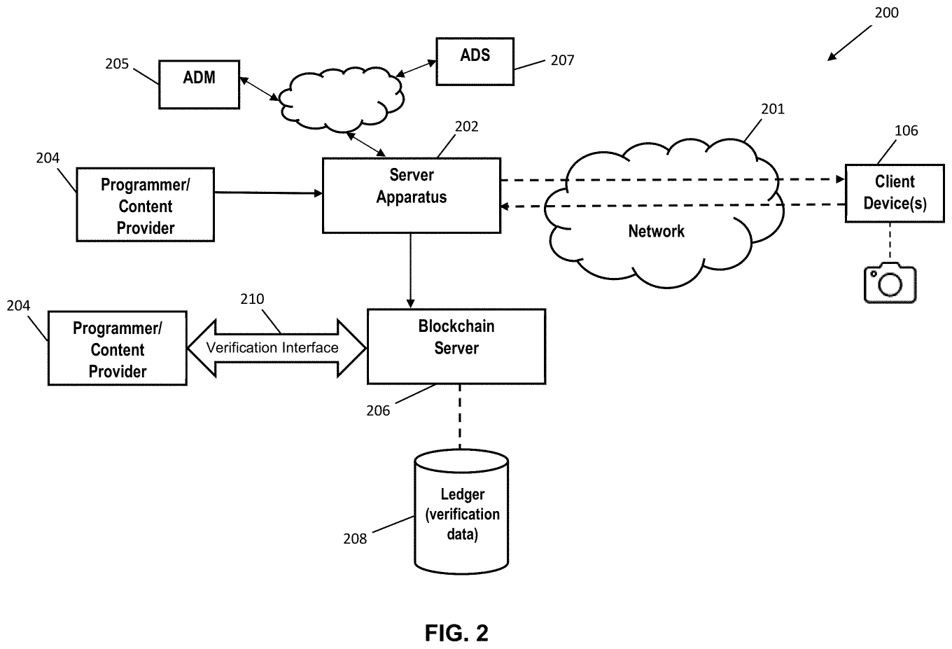

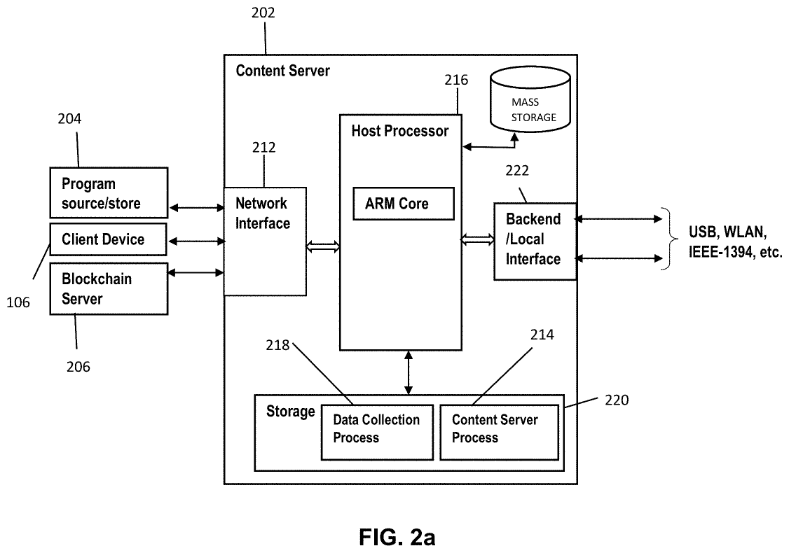

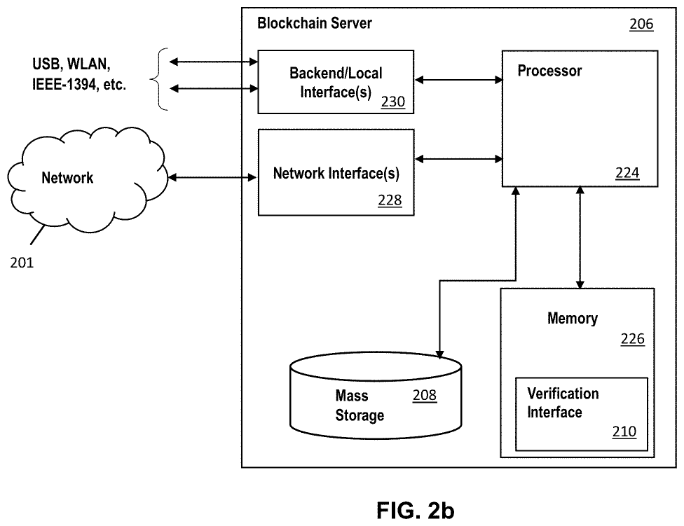

Referring now to FIG. 2, an exemplary embodiment of a blockchain-based verification architecture 200 specifically implementing the various aspects of the disclosure is shown and described. It will be appreciated that the architecture 200 of FIG. 2 can be used in conjunction with any of the foregoing network content distribution architectures (i.e., those of FIGS. 1-1c discussed supra), or can form the basis of its own distribution and delivery architecture.

Additionally, the blockchain-based verification architecture 200 of FIG. 2 in one embodiment may be located at the headend 150 of FIG. 1 or the CMTS 156 of FIG. 1a. In another embodiment the network 200 may comprise a separate entity in communication with the headend 150 and the CMTS 156. It is further appreciated that one or more of the components of architecture 200 may be disposed at various other locations as desired consistent with the architecture implemented (e.g., closer to the network edge, such as at the BSA hub in a BSA network). Moreover, while the architecture 200 of FIG. 2 illustrates basically an MSO-based system, one or more of the foregoing components may be third-party owned or operated.

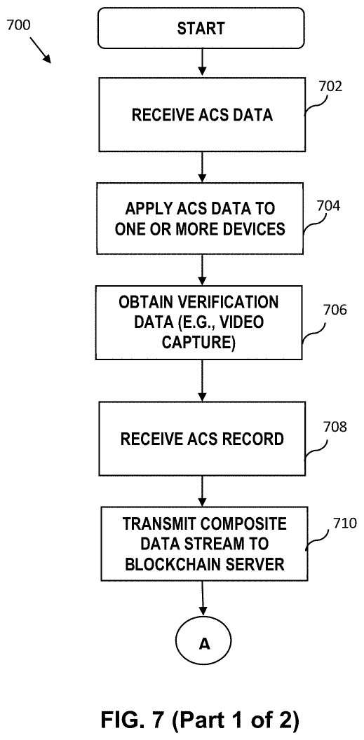

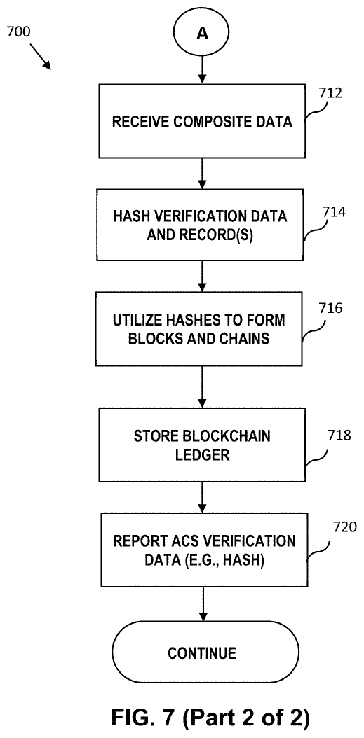

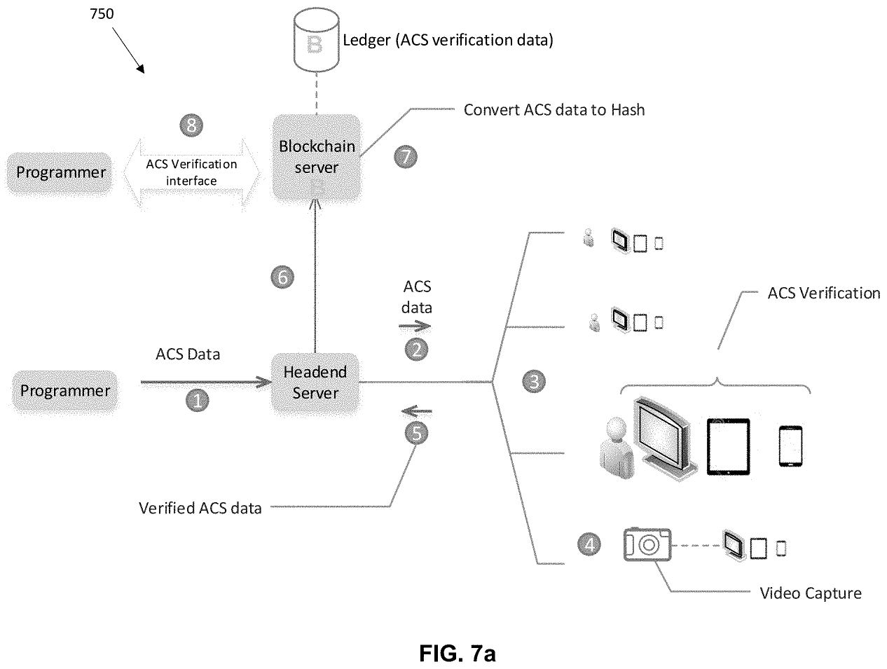

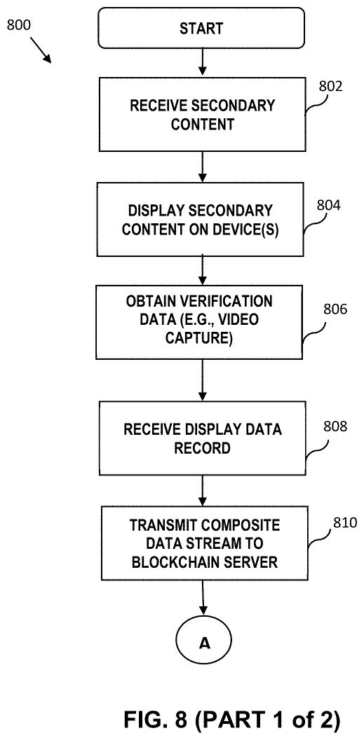

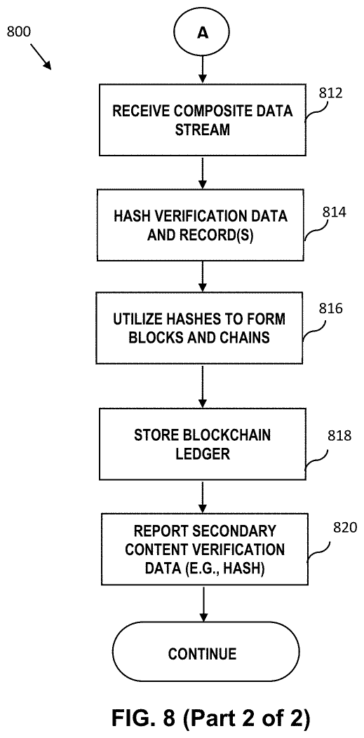

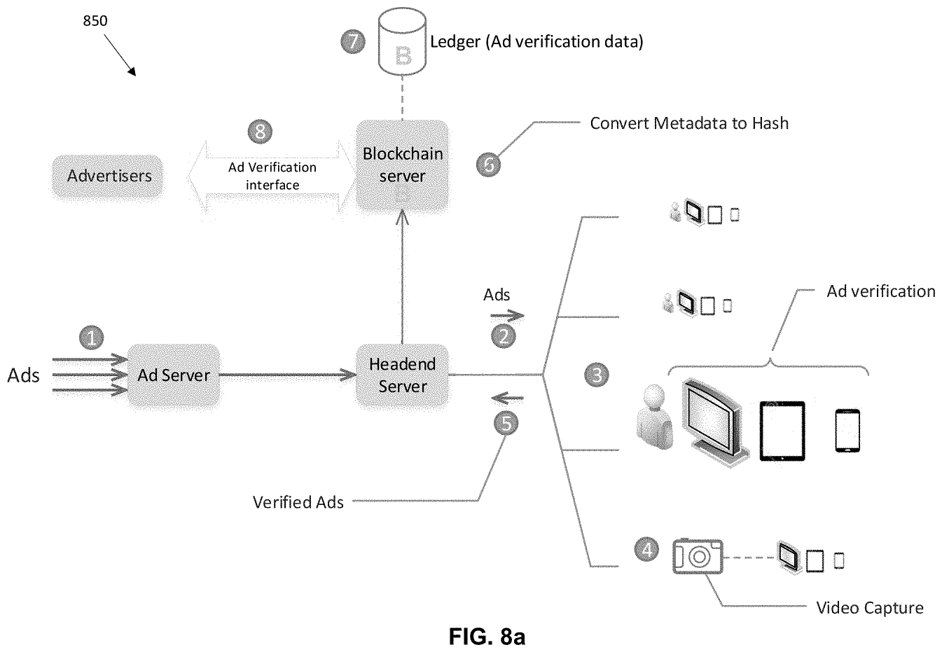

As shown in FIG. 2, the exemplary verification architecture 200 generally comprises one or more server apparatus or other computerized device 202. In operation, the server apparatus 202 obtains all of the necessary data for performance of the methodologies described below with respect to FIGS. 7 and 8. For example, in one embodiment, the server apparatus 202 is configured to receive data relating to alternate content switching (AC S) events (such as policies relating to “black out” events and data relating to appropriate alternate content) from one or more program sources 204 for application to one or more computerized client devices 106. In another embodiment, the server apparatus 202 is configured to receive a plurality of secondary content (e.g., advertisements, promotions or “info-mercials”, commercials, telescoping information/advertisements, and short segments), and/or data defining policies relating thereto and/or descriptive of the secondary content, from one or more advertisers or other content providing sources 204 for delivery to one or more computerized client devices 106 over a network 201.

In one implementation, the server apparatus 202 comprises a number of different functional software modules, including protocols for making calls or “pulls” of data from the various databases and other entities. For example, in one variant, a data pull or request is made to the client devices 106 to obtain data structures (e.g., records) and/or verification data (e.g., video captures) relating to the event(s). These accesses are made using suitable pull technologies, e.g., Microsoftnet technologies, or HTTP “GET” requests, for collecting data from the data sources. Alternatively, data from the various sources (e.g., client devices 106) can be “pushed” (e.g., based on occurrence of the event, according to a periodic schedule, when updated, etc.) and stored locally within the server apparatus 202.

In one exemplary embodiment, particularly useful in the method 700 of FIG. 7, the server apparatus 202 may include an alternate content server (ACS) configured to, inter alia, switch the primary content to the alternate content. Exemplary apparatus and methods for providing alternate content are described in co-owned U.S. patent application Ser. No. 14/133,495 filed on Dec. 18, 2013 and entitled “Methods And Apparatus For Providing Alternate Content,” which is incorporated herein by reference in its entirety, although other approaches may be used consistent with the present disclosure.

In another exemplary embodiment, the server apparatus 202 may be communicative with, or include, one or more advertisement service entities, particularly useful in the method 800 of FIG. 8. For example, the server apparatus 202 may communicate with or comprise an Advertisement Management Service (AMS) 205 and an Advertisement Decisioning Service (ADS) 207. The ADM is utilized to select individual ones of a plurality of secondary content for delivery to individual ones of the CPE 106. The ADM 205 is in communication with the ADS 207; the ADS determines individual ones of the plurality of secondary content from the content store to deliver to the CPE 106 based in part on data collected from a headend collecting entity.

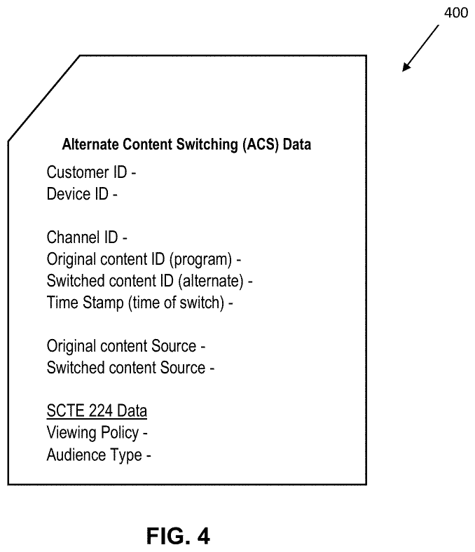

The client devices 106 may include end-user/customer devices (e.g., mobile devices, CPE, gateways, APs, etc.), test devices (which may be, e.g., located in a video operations data center (not shown)), or devices on a virtual machine environment. In one embodiment, the client devices 106 include a software process or application which enables the generation and transmission of records (such as the exemplary ACS record 400 in FIG. 4) and/or verification data. In one embodiment, the software process may be controlled by an operator of the network 200. For example, a video capture entity may be located at a data center or cable network headend/hub-office. The video capture entity may send a signal or command to the software process disposed at least substantially on the client device 106 (or a device in communication therewith, such as an upstream modem/router) that would cause the client device 106 to capture one or more images relating a particular event in order to verify the occurrence thereof. In an alternative embodiment, the software process may be an automated program, which, in one implementation, may be based on machine learning (ML) and/or AI (artificial intelligence) algorithms so as to enable, inter alia, identification of use cases or scenarios where verification may be required.

The generation of the verification data may be enabled via use of one or more capabilities of the client device 106. For instance, video capture capability and optical character recognition (OCR) with image comparison capabilities may be provided at the client device 106. The OCR and image comparison capability enables the client device 106 to verify images and text which appear for display at the client device 106. For instance, in order to validate that an ACS event or advertisement viewing did in fact occur, the server apparatus 202 is used to transmit a data message, composite video signal, or other communication to the client device 106. The client device 106 uses the message to determine whether the ACS event or advertisement viewing did occur, such as by recognizing text within the alternate or secondary content, and/or capturing one or more images of the alternate or secondary content image.

In another variant, QR codes of the type known in the art may be utilized as a visual mechanism for verification. In a further variant, a particular audio tone or set of tones transmitted as part of the delivery of the secondary content may be used as a verification mechanism. Yet other mechanisms consistent with the methods and apparatus described herein will be appreciated by those of ordinary skill given the present disclosure.

As discussed above, the video capture capability enables the client device 106 to capture one or more images, including a video segment. The video segment (e.g., video/audio clip of the ACS or secondary content display event) may also include a time-stamp of the event occurrence. As discussed in further detail below, a video segment with a timestamp fortifies the notion that the hash thereof is sufficient proof, as it is infeasible to modify/add the video clip later and obtain the exact same hash.

The verification data (e.g., video capture) may comprise metadata created during the occurrence of the event, and can be packaged in a prescribed format such as a markup language (e.g., XML, or JSON). International standards for audiovisual metadata, such as the ISO/IEC “Multimedia Content Description Interface” (also referred to as MPEG7), or the TV-Anytime Forum's “Specification Series: S-3 on Metadata,” incorporated herein by reference in its entirety, may be used as the basis for the metadata.

The software process of the client devices 106 may be further configured to transmit the records and verification data together as composite data to the server apparatus 202, where it is aggregated and transmitted to a blockchain server 206. Alternately, the composite data may be transmitted directly to the blockchain server 206 from the client device 106. The transmission of the composite data may be, e.g., event driven (i.e. based on the occurrence of a prescribed event occurring at e.g., the client device or within the MSO network), or may be based on a prescribed schedule, affirmative request, etc. The transmission may be conducted using suitable pull technologies, e.g., Microsoft.net technologies, or HTTP GET request, for collecting data from client devices 106. Alternatively, the composite data from the various clients 106 can be “pushed” (e.g., according to a periodic schedule, when updated, etc.) to the server apparatus 202 (or blockchain server apparatus 206). In one implementation, the verification data may be sent, via a simple network management protocol (SNMP). In another implementation, the verification data is published to the server apparatus 202 (or blockchain server apparatus 206). In one embodiment using a WebServices interface, although other approaches may be used consistent with the present disclosure.

In one embodiment, the server apparatus 202 is configured such that once the composite data is received, the server apparatus 202 reports the data associated with the ACS and/or secondary content display events to a third party entity (such as program source or advertiser 204). It is noted that under extant reporting paradigms, voluminous reporting data is sent to the third party entity with which the content distributor is contracted. However, such reporting or explicit queries into a content distributors database (e.g., for specific switches, monthly channel reports, provider reports and global reports) may expose information sensitive to the consumer, or information that is proprietary and protected under contractual obligations. Additionally, attempts to protect such data utilizing one-way cryptographic hashes are problematic, as sensitive data can still be gleaned therefrom, especially with modern computing power.

In other words, in order to deem that a content switch or an impression (e.g., a click) or other event is legitimate under existing models, third party verification entities typically require disclosure of information that at least one of the parties to the transaction (e.g.,. the content provider) has deemed proprietary and protected (e.g., the type of device the client is using, etc.). For that reason, the content provider does not want to share such information with the third party entity, but the third party entity also does not want the content provider verifying their own data or other such “self-policing” model. In contrast, by utilizing an automated crypto-hashing based block formation, which are then linked to form the blockchain, the present disclosure advantageously enables independent verification of such data associated with the (e.g., ACS and/or secondary content display) events while maintaining privacy of the users, as the hashes of the data provide sufficient proof of the events.

Referring back to FIG. 2, in one embodiment, the records may be transmitted together with the verification data as a composite data structure or stream to the blockchain server 206.

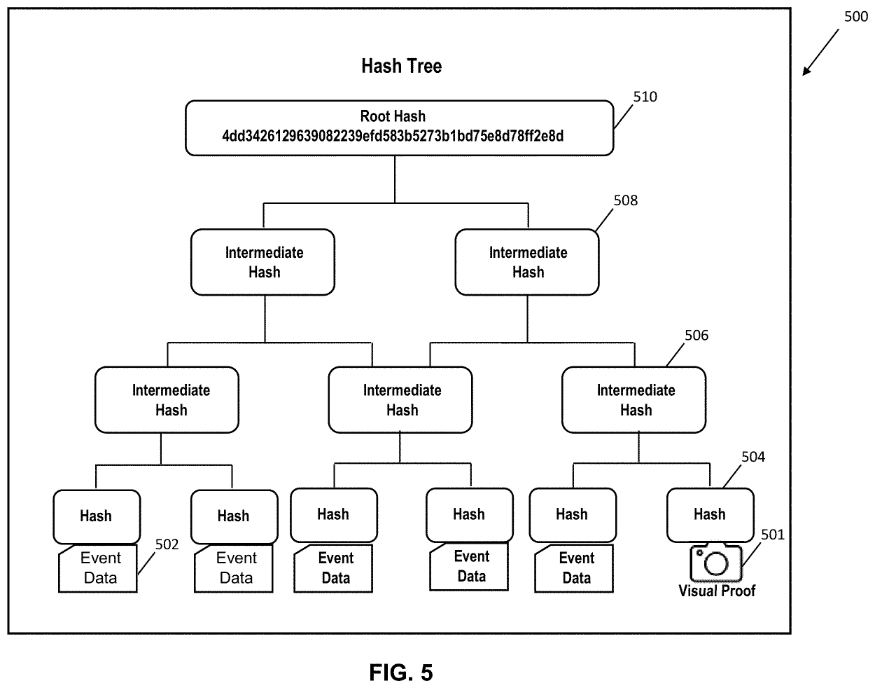

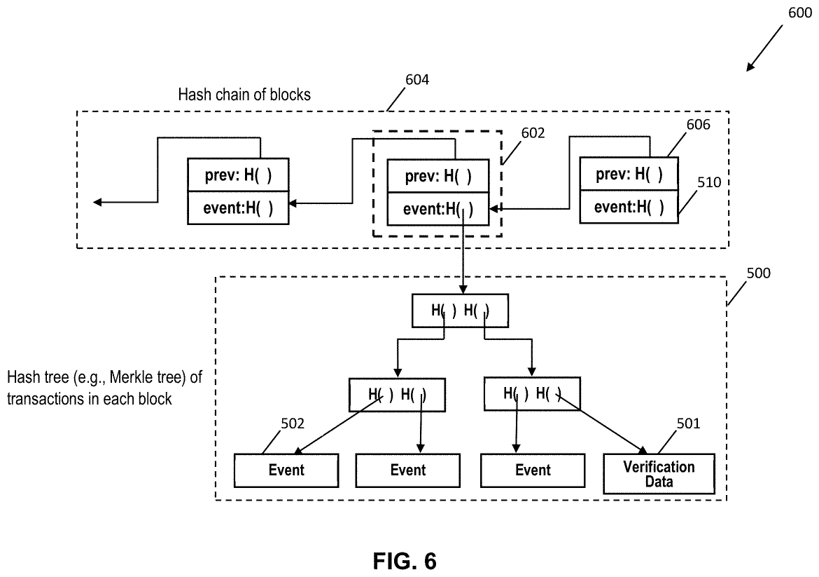

The blockchain server 206 is configured to automatically perform a hashing algorithm utilizing the composite data in order to form blocks and chains of the blockchain ledger. See FIGS. 5 and 6, as well as the supporting discussion corresponding thereto for more details regarding the hashing and blockchain processes.

In one embodiment, the blockchain ledger may be stored in a repository or database 208 of the network 200. Data can be extracted from the blockchain readily accessible database 208 that is updated with each block The database 208 may be maintained by the MSO of network 200 or by a third party entity communicative with the MSO, such as via a trusted (network) relationship. The blockchain ledger may be “pushed” (such as via periodic updates) to a network content provider or third party service 204, or retrieved via a query or data “pull” (e.g., from the network content provider or aggregator). Additionally, an interface 210 may be provided for accessing the data by programmers (or proxies). In one variant, the interface may be based on PKE (public/private key encryption).

### Server Apparatus

FIG. 2a is an exemplary embodiment of the server apparatus 202 of the type used in the architecture of FIG. 2. The server apparatus 202 includes a network interface 212, which receives the primary content, secondary content, and/or the alternate content, as well as any data associated therewith (e.g., ACS data or metadata or other descriptive data), from the content source (e.g., program source, advertiser, etc.) 204 or the content server 214. The server apparatus is also configured to receive requests from the client device 106, and forward these requests to a processor 216. The requests may be received through the primary network interface(s) 212, or through one or more of a plurality of backend or local interfaces 222 such as e.g., USB, IEEE-1394 (Fire Wire), Thunderbolt, IEEE Std. 802.11 (Wi-Fi), etc.

The processor 216 is configured to communicate with a storage device 218, where the storage device 218 comprises at least one computer program executable on the processor 216. The computer program comprises a plurality of instructions which are configured to, when executed, receive data relating to the event, and based on such data, cause an event (e.g., ACS event or secondary content display event) at the client device 106. For example, the event may be a display of secondary content or switch to alternate content which is caused by the secondary or alternate content be transmitted from content server process 214 to the client device(s) 106. In one variant, network services are sent “over the top” of other provider's infrastructure, thereby making the service network substantially network-agnostic. That is, content server 214 may be configured to deliver Internet data and OTT (over-the-top) services to the end users via the Internet protocol (IP) and TCP (e.g., over a 5G radio bearer or other interposed infrastructure of the MSO or a participating MNO (mobile network operator)), although other protocols and transport mechanisms of the type well known in the digital communication art may be substituted. In another variant, a cooperative approach between providers is utilized, so that features or capabilities present in one provider's network (e.g., authentication of mobile devices, such as via an IEMI or AAA server) can be leveraged by another provider operating in cooperation therewith.

In one embodiment, the server apparatus 202 is configured to obtain one or more records and/or verification data from one or more respective client devices 106. The records may include various information and/or identifiers about the event, or failure thereof. For example, a record may include one or more of the following: (i) network or user-specific policies, (ii) program identification, (iii) channel identification, (iv) client device information such as MAC or IP address, status, etc., (iv) timestamp data, as well as (v) geographic or location information such as IP address or association with a known network node, a zip code, latitude/longitude, GPS coordinates, etc. See FIG. 4, which illustrates for an exemplary ACS record. In one variant, the server 202 causes the client device 106 to generate the ACS record (for example, based on the occurrence or failure of the event, or based on the verification of the occurrence (or failure) of the event), such as via a GET request, call to an API operative on the client, or other mechanism. The verification data may include textual, audio, or visual verification of the occurrence of the event as previously described. In one variant, the server 202 causes the verification of the event; e.g., automatically, such as by utilizing machine learning or AI processes to identify a scenario where verification is required and based thereon, initiate the verification. In an alternative implementation, an operator of the server apparatus 202 may cause the verification, such as by causing a signal or command to the client device(s) 106 via the network interface 212.

The server apparatus 202 collects/aggregates the records and verification data received from the client device(s), and transmits the composite data to the blockchain server 206, the latter now described in greater detail.

### Blockchain Server

FIG. 2b illustrates one exemplary embodiment of a blockchain server apparatus 206 useful with the present disclosure. As shown, the blockchain server 206 generally comprises one or more network interfaces 228 for interfacing with other entities of the content delivery network and/or the managed network headend 150, a processor 224, a memory apparatus 226, mass storage 208 (e.g., RAID array, solid state drive (SSD), HDD, and/or NAND/NOR flash memory), and may include a plurality of backend or local interfaces 230 such as e.g., USB, IEEE-1394 (Fire Wire), Thunderbolt, IEEE Std. 802.11 (Wi-Fi), etc.

In one embodiment, the blockchain server apparatus 206 includes one or more computer programs with a plurality of instructions which when executed by the processor 224, cause the blockchain server apparatus 206 to receive the composite data from the server apparatus 202, process the composite data to generate one or more blocks, and utilize the one or more blocks to form a blockchain. More specifically, the processing includes automatically performing at least one cryptographic hash function (e.g., SHA-256) on one or more record(s) and/or verification data to generate hashes thereof. The records may be in a structured format (such as JavaScript object notation (JSON), which is a lightweight data-interchange format), so that the calculated hash is unique on a per—record basis. As described in greater detail elsewhere herein, a root hash of an inverted tree structure (e.g., Merkle tree) is then computed using those hashes (of the record(s) and/or verification data) and intermediary hashes. The root hash of the current block is then hashed together with the root hash of a previous block, thereby generating a block hash. The linking of the root hash with the root hash of a previous block constitutes the “chain” of the blockchain. Accordingly, the blockchain itself is tasked with validating the events via the automated cryptographic hashing in a hierarchical manner. The validation includes validating the integrity of the data, such that no event is reported twice.

In one embodiment, the hashes may be generated using memory 226 of the blockchain apparatus 206. For instance, the blockchain server apparatus 206 may perform a search function on memory 226 to generate an output (e.g., proof-of-work or proof of stake). Additionally, the blockchain server apparatus 206 may store processed data (intermediary (e.g., hashes) or final form (e.g., blockchain ledger)) in memory or a mass storage device 208, or alternatively in attached local storage or even cloud storage (which may include both MSO and non-MSO network storage).

In one implementation, the application computer program is rendered in a C# (“C Sharp”) object-oriented programming language (C# was chosen in the exemplary embodiment for use of the .NET Framework, which advantageously provides large libraries with built-in capabilities and methods useful in the context of the present disclosure), although it will be appreciated that other languages may be used consistent with the present disclosure.

The blockchain server 206 also includes a verification interface 210, which is useful for enabling access to various data, such as the hashes of the records and/or verification data, the blockchain ledger, schedule data, reports, etc. In one embodiment, the verification interface 210 is based on public/private key encryption (PKE), although other approaches may be used. Moreover, it is appreciated that the verification interface 210 may also include a remote interface (such as via a web-based client application) for the program source/advertiser 204, by which the program source/advertiser 204 can log in to a secure MSO server, review the various data (e.g., blockchain ledger, hashes), provide input as to desired performance, markets, types of good/services, budget, provide payment source information, and other information. For instance, an API may be utilized wherein “calls” to the API via remote device will cause the server apparatus 206 to return the requested data.

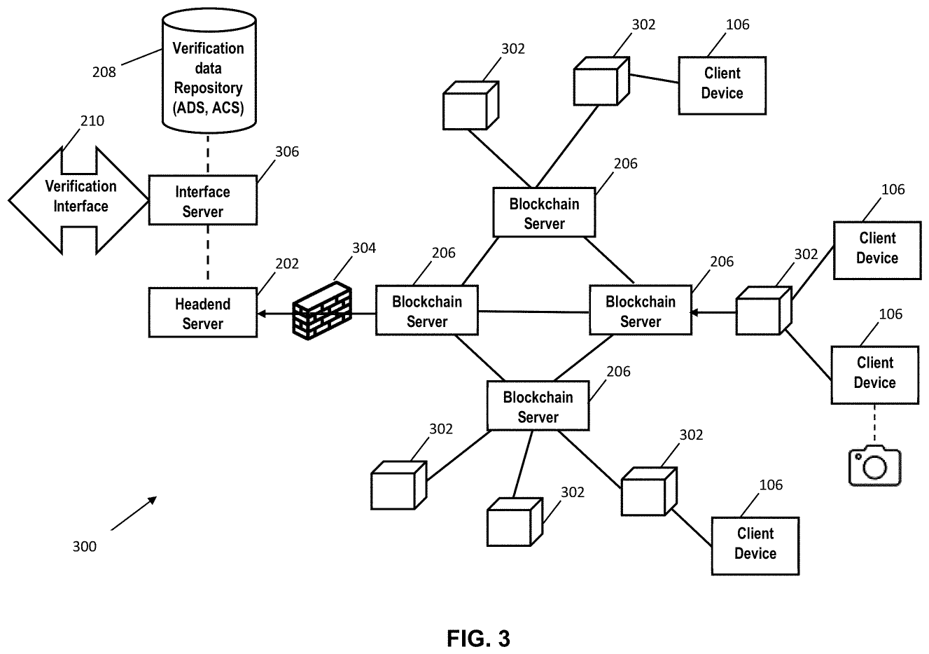

Moreover, as consistent with the distributed architecture 300 of FIG. 3 discussed below, in one embodiment, the blockchain process (i.e., computerized logic rendered as code) is implemented on one or more servers (which may be geographically localized, such as in a server “farm”, or alternatively distributed across multiple geographic regions), and may also be physically and/or logically integrated with other components of the MSO network, such as “oracles”, client devices, etc.

### Exemplary Distributed Architecture

Referring now to FIG. 3, an exemplary embodiment of a distributed architecture 300 specifically implementing the various aspects of the disclosure is shown and described. It will be appreciated that the architecture 300 of FIG. 3 can be used in conjunction with any of the foregoing network content distribution architectures (i.e., those of FIGS. 1-1d and 2 discussed supra), or can form the basis of its own distribution and delivery architecture.

The distributed architecture 300 of FIG. 3 can be considered a type of “mesh network” including a plurality of blockchain servers 206 (i.e., servers running the blockchain protocol). Additionally, one or more oracles 302 subtend from each blockchain server 206, and one or more client devices 106 devices subtend from each oracle 302.

As blockchains record data sequentially, data points from outside the chain require an intermediary entity (such as an oracle 302) to access the chain. Typically, an oracle would trigger e.g., a smart contract (containing the instructions in computer code) once one or more specified or pre-defined conditions are met. However, in the context of the present disclosure, events (e.g., ACS and advertisement viewing events) trigger the oracle 302 to initiate the code snippet for writing events to the block. Then, the blockchain protocol takes over the process, cascading the (e.g., Merkle) tree formation, and creating the blockchain.

In one embodiment, the client device(s) 106 report those events (via, e.g., a standard push/pull mechanism) to the blockchain servers 206 based on the occurrence of the events (e.g., ACS or advertisement display events). In one variant, a network entity (such as the server apparatus 202) selects a “compute-node” per event stream as the designated creator of blocks. In one implementation, the selection could be based on the rules previously established, such as the current load. Other nodes would forward event data they receive to the designated compute-node. According to the present disclosure, there is no need to replicate the chain to all nodes (i.e., no mining).

Additionally, the blockchain is tasked with validating the events. In some variants, the validation includes validating the integrity of the data, such that no event is reported twice.

Yet additionally, a heartbeat signal or other mechanism may be used to ensure the client devices 106 are not down/inoperative.

The calculated hash data is stored in an external server (e.g., interface server 306) database for transmittal/retrieval by external entities, such as program sources or advertisers 204.

It will be appreciated that in various incarnations, the blockchain network or components thereof may be internal or external to an enterprise or entity (behind a firewall 304).

Alternatively, in other embodiments, the blockchain network could be shared by multiple enterprises via VPN tunnels (a federated/consortium blockchain).

### Exemplary Blockchain Elements

Blockchains offer an indelible record of transaction data. A “blockchain” is typically referred to as a shared ledger consisting of an ever-expanding chained sequence of data blocks. In current blockchain systems, each “block” includes a plurality of “valid” transactions; and typically there are around a thousand (1000) transactions per block. That is, the ledger is shared among multiple peer nodes and multiple peer nodes must validate each transaction within each block in order for the block to be added to the blockchain. The peer nodes validate the transactions by comparing their respective copies of the shared ledger to each other; more specifically, a root hash (or block hash, i.e., a hash computed from the root hash of the current block and the root hash of the prior block in the chain) of a block of one nodes copy of the shared ledger is compared to a root hash (or block hash) for that block of another peer nodes copy of the shared ledger. If the root hashes (or block hashes) in each shared ledger match, the block is considered valid, and therefore each transaction therein is valid as well. If one transaction within the block is invalid, the hash for that transaction will be different, thereby affecting the root hash (or block hash), and that node with the invalid transaction will have a different root hash (or block hash) for the block than another node.

However, in contrast to “transactions” as currently used in the art, the present disclosure utilizes records and/or verification data associated with “events” (e.g., ACS, advertisement display events, etc.). The integrity of the data relating to these events is maintained by cryptographic hashing of each block, as well as tying it to the prior block. Hashing, such as SHA-256, is a one-way function that is extremely hard to break. It is not at present possible to reverse engineer a secure hash and obtain individual data components. Even a minute modification to the data will affect the hash value of the entire block, as well as the chain.

Additionally, since the hashes of such data serve as sufficient proof the events occurred (or did not occur), only the hashes relating to the events (or verification data thereof) need to be communicated to third parties, not the data itself, thereby reducing the voluminous reporting data communicated between content distributors (e.g., MSO) and third parties (e.g., program sources, advertisers, content providers) in existing systems.

The data hashed in the present disclosure may include records relating to the events and/or verification data relating to verification of the occurrence of the event. The records include data representative or descriptive of certain events (e.g., ACS events and secondary content display events), or failures thereof. In one embodiment, the records are in a structured format (such as JSON), so that the calculated hash is unique per record. FIG. 4 shows an exemplary record 400 of an ACS event according to the present disclosure.

As shown in FIG. 4, the ACS data record, according to various embodiments, may include one or more of the following: (i) customer identification (ID), (ii) device ID, (iii), channel ID, (iv) original content ID (program), (v) original content source, (vi) switched content ID (alternate), (vii) switched content source, (viii) timestamp (time of switch), and (ix) SCTE data (such as, e.g., viewing policy and audience type). Other identifiers of the record 400 might include e.g., headend IDs (e.g., IDs assigned to IRDs, vIRDs, or other devices by a network entity), geographic or location identifiers, system identifier, market identifier, etc.

In some variants, the record 400 may also include a description of appropriate services based on negotiated viewing rights. For example, the record may include a description of rules or policies such as, e.g., (i) Golden Globe awards viewership may be limited to in-home devices only, (ii) an old black and white movie may not have rights yet cleared to be viewed on tablet devices, or (iii) a 4K movie may only be shown on a certain iOS due to version incompatibilities.

It is noted that any record can omit one or more of the aforementioned IDs/descriptors as well. For example, a record having the content IDs may be sufficient, enabling verification of the integrity of the content itself; however, including data (e.g., data representative of a certification) or identifiers relating to the source of the content may add an additionally level of verification, enables verification of where the content originated.

Additionally, if an event did not occur, that failure may be captured and recorded as well. In the instance primary content is not to be displayed to a requesting device, the display thereof may instead revert to a “slate” (or black) screen or a message (i.e., a notification for the reason why an error occurred). The slate screen or message may be displayed purposefully and/or upon a network error. For example, the slate screen or message may be displayed when the server 202 and/or another server in the network 200 fails to provide the client device 106 with the appropriate alternate content. In this instance, the client device 106 may generate a record of this failure; the record may include data relating to the slate static content and/or the message. In another variant, (non)verification data may be generated, which may include, e.g., an image capture of the slate screen and/or message.

Yet additionally, as noted elsewhere herein, the ACS example is merely one exemplary application contemplated by the present disclosure. A record or data structure can be created for any type of event. For example, a record for a dynamic advertising application might be similar to the record 400 for the ACS application, but would regard secondary content instead of alternate content. For example, a record for dynamic advertising might include one or more of the following: (i) customer identification (ID), (ii) device ID, (iii), channel ID, (iv) primary content ID (program), (v) primary content source, (vi) secondary content ID (advertisement), (vii) secondary content source, (viii) timestamp (time of display of secondary content), (ix) SCTE data (such as, e.g., viewing policy and audience type), and (x) beacon or tag data (e.g., percentage).

Various other applications are completed by the present disclosure as well. For example, for applications relating to biometric searches (e.g., DNA record searching, retinal scanning, fingerprint searching through a fingerprint database, etc.), the record might include biometric data (DNA, fingerprint data). Similarly, for environmental or natural population characterization records might include data relating to, e.g., climate predictions, biological population simulations, etc.

Referring now to FIG. 5, an exemplary hash tree 500 useful with the various aspects of the present disclosure is provided. In the exemplary embodiment shown in FIG. 5, the hash tree 500 comprises an inverted tree structure (i.e., a Merkle tree); and more specifically, a Binary tree or Patricia tree, which pairs records and/or other data, and hashes of those records and/or data.

However, other configurations may be utilized as well, such as those that combine more than two (2) records/data/hashes. The hash tree 500 includes a plurality of hashes 504 for each record 502 and/or other dissimilar data (e.g., verification data) 501. Each record 502 (and/or verification data 501) is cryptographically hashed in a hierarchical manner (“Merkle Tree”) until a root-hash 510 is reached. That is, a hash 504 is generated for each record (e.g., ACS or display event data) 502 as well as for each piece of dissimilar data (e.g., video capture) 501. The records and verification data can be hashed utilizing any hash function known in the arts including, e.g., Tiger, MD5, SHA, etc.

Six (6) hashes of five (5) records and one (1) video capture are shown in FIG. 5; however, this number is merely exemplary. Each block can include thousands of records and e.g., video captures. In one embodiment, each block may contain event (e.g., ACS) data per geographic region (spatial), or a viewing policy restriction applied through a period (temporal). Storing and transmitting all the hashes for those records (and e.g., video captures) can require extensive storage and bandwidth. Utilizing a Merkle tree solves that problem because combining (and in the context of a Binary tree or Patricia tree, pairing) records and hashing them together reduces the number of hashes to be stored are reduced (by half, in the context of a Binary tree or Patricia tree). Combining and hashing more hashes together (e.g., combining intermediary hashes 506 together to obtain intermediary hash 508 and then combining those hashes) will result in one hash (the root hash 510) to store; and therefore, the root hash is deterministic based on the hashes of all the underlying records/data. The final root hash 510 constitutes proof of the recorded events in the block 500, since it is mathematically impossible to reverse the process. Hence, the final (root) hash 510 not only acts as sufficient verification of an event (e.g., ACS) contractual obligation, but it also negates the need for sending volumes of sensitive customer data back to each program source. Thus, the present disclosure also advantageously enhances customer privacy.

Additionally, combining the video hash with dissimilar data (e.g., event data) in a Merkle tree calculation to generate proof of the event (e.g., ACS) provides heretofore unrealized benefits. The video segment (e.g., video/audio clip of the ACS or secondary content display event) may, in some variants, include a time-stamp of the event occurrence, which advantageously fortifies the notion that the hash is sufficient proof. It is infeasible to modify/add the video clip later and obtain the exact same hash.

Referring now to FIG. 6, an exemplary blockchain structure 600 useful with the various aspects of the present disclosure is shown. The blockchain structure includes a plurality of blocks 602 linked together to form a chain 604. Each block includes at least a hash of the previous header 606 (i.e., a root hash of the previous block 602) and a root hash 510 for the Merkle tree 500 for the records 502 and/or verification data 501 for that block. Additionally, a block hash may be computed from the root hash 606 of the previous block 602 and the root hash 510 of the current block. However, a block may include other data as well including, e.g., a timestamp, a difficulty value, a proof of stake nonce, etc. Yet, it is noted that the blockchain 600 of the present disclosure is different from well-known blockchains such as Bitcoin or Ethereum. The blockchain 600 of the present disclosure, in various embodiments, does not use “coins”, and there is no buying/selling among participants; therefore including, e.g., a proof of work nonce may be obviated.

More specifically, blockchain structures vary by implementation, and it is hard to define a standard model. For example, the second largest cryptocurrency, Ripple, is missing the salient “distributed ledger” feature. Likewise, Oracle and Smart Contract concepts were introduced by Ethereum and were not part of original Bitcoin protocol. Also, unlike Bitcoin, most private blockchains do not have group consensus mechanism (mining), and some even advocate centralized control. In spite of the variations, all major blockchain implementations share one commonality: automated crypto-hashing based block formation, which are then linked to form the blockchain. The blockchain 600 of the present disclosure shares that property as well.

However, as mentioned above, the blockchain 600 of the present disclosure is different from well-known blockchains such as Bitcoin or Ethereum, in that, e.g., it does not use coins and there is no buying/selling among participants. The blockchain 600 of the present disclosure only utilizes cryptographic hashing to record “events.” The hierarchical hashing is used to stamp/identify each data block, and connect the blocks as a linked-list to form a blockchain. In one embodiment, an optional, representative video clip 501 is included with the event data 502 for visual proof. The root hash 510 is then combined with previous block hash 606 of the chain to compute a block hash.

With respect to the foregoing “block creation” and “block mining” features, as the blockchain 600 of the present disclosure, in one embodiment, is contemplated as a private blockchain with full control by the network administrator, the concept of “data mining” (or the usage of “nonce” to adjust the difficulty), is not relevant. Any manifestation of Byzantine faults will be resolved by the network administrator, who has full ownership of the chain.

With respect to the foregoing “consensus mechanism” feature, in the present disclosure, since there is no interaction among the devices (except with the server), consensus mechanisms such as Proof-of-Work (POW) are not applicable. The blockchain mechanism of the present disclosure could actually be considered a type of POS (proof-of-stake), with one party governing the decision making process.

With respect to the foregoing “smart contracts” feature, smart contracts are code snippets with conditions and actions listed. They typically run on top of the blockchain network layer. In general implementations, they trigger payments once the conditions of a transaction are met. In the present disclosure, video “events” are used in place of “transactions.”

### Methodologies

As explained elsewhere herein, the aforementioned blockchain-based architectures 200, 300 of FIGS. 2 and 3, respectively, may be suitable for a wide range of applications. FIGS. 7 and 8 described below are but two exemplary applications contemplated by the present disclosure, and should be considered merely illustrative of the broader principles.

### Exemplary Alternate Content Switching (ACS) Operation

In FIG. 7, an exemplary embodiment of a method 700 for verifying alternate content switching (AC S) event data utilizing a blockchain apparatus within a network, such as the exemplary networks of FIGS. 1-1c, 2, and 3 is illustrated.

The methodology 700 begins at step 702, where ACS data is received. Generally, an operator of a managed content delivery network, such as those of FIGS. 1 and la above, negotiates rights to content and related data with various content providers or program sources 204. Among these rights are rules designating content which is specific to, e.g., a particular geographic region, devices, operating systems, etc. This may include rules indicating certain geographic areas, devices, etc. which are not to receive certain content (so called “blackouts”), as well as alternatively programming that these areas, devices, etc. are supposed to receive. Other content restrictions or guidelines may also utilized.

As will be understood in the present context, the terms “geographic region” and “location” may refer to a given point of interest (e.g., ZIP code, account address, GPS coordinate, geographic feature, etc.), a broader region (such as a metropolitan area, state, territory, etc.), or even a relative geographic reference (e.g., an n-mile radius around a fixed or moving reference point), as well as those tied to network topology (e.g., an IP address or other network address may also correspond to a given geographic region).

Moreover, the term “blackout” as used herein may refer to content which has temporal or other aspects as well as geographic ones. For example, programming may only be “blacked out” for a prescribed period of time (e.g., during certain weeks of the year, through the first half of a football game, up until a certain point in a local, state, or federal election, etc.), after which it is freely available for viewing.

It will also be appreciated that the geographic context or relationship of certain content may be a function of other variables or considerations, such as time. For instance, the geograhic relevance or restrictions on a given content element may expire after a prescribed period, or after certain events occur, thereby making it freely available for distribution.

Moreover, a given content element itself may change its geographic relevance or context intra-element (i.e., one portion of the content element may be relevant to one location, and another portion to another location), such as where a travel-related program addresses different travel destinations, or a sports program switches between games at different locations or with teams originating from or associated with different locations.

Hence, the present disclosure contemplates not only the enforcement and delivery of “static” geographically relevant content (i.e., content whose relevance does not change), but also content with dynamically changing relevance or restrictions.

In one embodiment, the negotiated rights are implemented by the content distributor (e.g., MSO). Accordingly, and as illustrated in FIG. 2, ACS data is provided by the program sources 204 to the server appartus 202 to be applied to one or more services (e.g., IP/ABR/CBR delivered services and/or QAM delivered services). The ACS data may indicate one or more alternate content rules or policies. Some previously identified examples of these ACS policies might include: (i) viewership to be limited to in-home devices only, (ii) content which may not yet have rights cleared to be viewed on tablet devices, or (iii) content may only be shown on a certain device O/S due to version incompatibilities. In each case, the viewer is precluded from watching the scheduled program, and would be directed to a static image (“slate”) or to another TV channel (alternate content).

Additionally, the ACS data may include various information and/or identifiers (such as e.g., headend IDs, geographic or location identifiers, system identifier, market identifier, program ID, stream ID) that are associated with appropriate services based on negotiated viewing rights. For instance, the ACS data may include a headend identifier (or other device- or user-specific identifier) referenced to an alternative program. The headend ID can be used to identify a given requesting user device (e.g., mobile device) and/or associate it with a given geographic location or region.

At step 704, the ACS data is applied to one or more devices. In one embodiment, step 704 includes providing content to one or more client devices 106 from the server apparatus 202 or any other component of network 200 in accordance with the policies or rules indicated in the ACS data, as described above. In one implementation, the content includes at least primary content (which may be subject to a blackout in some service areas) and an alternate content (which replaces the blacked out content in the given service areas). The primary and/or alternate content may comprise e.g., a movie, TV show, live programming, etc. In addition, the alternate content may comprise infomercials and/or advertisements specific to the service area of the client device 106, slate static content (e.g., a black screen), a message (i.e., a notification for the reason why the primary content is restricted), or alternate live programming. A myriad of other content formats and types are appreciated, the foregoing being merely exemplary in nature.

Additionally, the primary content and the alternate content are marked at their boundaries (such as with a start mark and a stop mark). As discussed in elsewhere herein, in one embodiment, the markers may be well-known SCTE-35 markers; however, other indicators or flags may be used with equal success. For example, the program boundaries themselves may be utilized as content flags or markers which are sufficient for the purposes of the present disclosure. The markers may be embedded into the content prior to the server 202 receiving both the primary content and the alternate content.

SCTE-35 markers are disclosed in American National Standard-ANSI/SCTE 35 2012, Digital Program Insertion Cueing Message for Cable, by © Society of Cable Telecommunications Engineers, Inc. 2012, which is incorporated herein by reference in its entirety. The SCTE-35 marker defines the cue messages that are embedded in the primary content and the alternate content. The SCIE-35 marker also defines upcoming splice points and other timing information. However, other mechanisms for indicating positions within both the primary content and secondary content for a switch may be utilized as well (including for example, segmenting the content, marking a private data field in the MPEG stream, manifest marking, video comparison tools, watermarking, etc.).

In one variant, an encoder may be used to mark the primary content and the alternate content with start and stop markers, such as SCTE-35 marker described above. It is appreciated, however, that any combination of the components in network 200 may be used to mark one or more of the alternate content and/or primary content. The encoder can further be utilized to encode the content using a desired codec for an MPEG-4 format. Additionally, the encoder may mark the primary content and/or the alternate content as discussed above to indicate appropriate start and stop points for switching (where necessary) in accordance with the policies/rules indicated in the ACS data.

The aforementioned markers may enable automated switching from the primary content to the alternate content. For example, the marker (whether SCTE-35 or otherwise) could trigger the server apparatus 202 to automatically switch the primary content to the alternate content when the client device 106 requests the primary content. This may occur via one or more components and/or servers within the network 200 which process the primary content and, when a marker is detected (e.g., when the primary content is identified as restricted or “blacked out”), is prompted to identify (via use of the ACS data in one implementation) whether the requesting device is among the devices which should have the requested (primary) content or alternate content delivered thereto, and in the instance it should have alternate content provided thereto, determine (via use of the ACS data in one implementation) the appropriate alternate content for the requesting device.

In another alternative, the server apparatus 202 (or another server in the network 200) merely references the ACS data and sends to the client device 106 the appropriate alternate content, and the device 106 itself is charged with performing the aforementioned switching when the marker is encountered.

In yet another embodiment, the server apparatus 202 is further configured to receive a tuning request from the program source 204, or other entity within network 200. Based on the request, the server apparatus 202 references the ACS data to determine the appropriate alternate content and either sends alternate content to an encoder entity to be encoded, or to a packager entity to be conditioned, or directly to the client device 106 to be viewed.

In yet another embodiment, the client device 106 allows for manual intervention on any appropriate alternative content. The manual intervention may include enabling an operator to manually complete switching from the primary content to the alternate content, and/or manually insert the alternate content when the automated switching from the primary content to the alternate content has failed. The operator may also start and stop the alternate content for such cases as when the primary content (e.g., restricted or “blacked out”) is delayed, cancelled or overrunning its schedule time. In the case where the primary content is overrunning its scheduled time, the operator may start a new alternate content when the switched-to alternate content ends.

In the case where the break in the primary content ends early, the operator may stop the alternate content and switch back from the alternate content to the primary content. The operator may also modify or remove the marker (whether SCTE-35 or otherwise), which triggers the server 202 to automatically switch the primary content to the alternate content, in the cases where the primary content is no longer restricted or “blacked out” for a particular service area. In yet another embodiment, the manual intervention may include enabling the user to access the alternate content list and replace the alternate content provided to the client device 106 with another appropriate alternative content (e.g., localized paid-for content, interstitial programming, etc.). The manual intervention may further include enabling the user to enable closed captioning, descriptive audio and/or subtitles. In yet another embodiment, the server apparatus 202 may be further configured to have a login function, which allows the program source 204 to login and manually intervene as discussed above.

Returning to FIG. 7, at step 706, verification data is obtained or collected. The verification can be caused or performed manually by an operator, or via an automated program such as those based on machine learning. In one embodiment, the verification data may comprise metadata information packaged in a prescribed format such as a markup language (e.g., XML, or JSON).

In some embodiments, the verification data (e.g., audio, video, and/or text data) is obtained by the server apparatus 202 from the client device(s) 106 via any push/pull mechanisms, as described above. In some variants, video capture capability and/or optical character recognition (OCR) with image comparison capabilities may be provided at the client device 106. The OCR and image comparison capability enables the client device 106 to verify images and text which appear for display at the client device 106. For example, in one variant, in order to validate that the ACS event did in fact occur, the server apparatus 202 may transmit a data message, composite video signal, or other communication to the client device 106. The client device 106 uses the message to determine whether the ACS event did occur, such as by recognizing text within the alternate content, and/or comparing the image of the alternate content that was displayed by the client device 106 to an image of the alternate content that was transmitted to the client device 106 in the message.

In another variant, the video capture capability enables the client device 106 to capture video (and/or audio) of the actual switch (based on, e.g., timing information in the ACS data used to cause the switch) or the alternate content being displayed on the client device 106 after the switch occurs.

For integrated receiver/decoder (IRD)-based sports blackout events, the verification data may be relatively simple as the audience segments are geographically-based (a collection of zip codes served by an IRD/Virtual-IRD). For example, if there is an IRD in a particular location (e.g., San Diego) which is associated with a number of devices/households in that area, a device could be put behind that IRD to check that the IRD received the correct commanding information and switched, and therefore each of those devices in the area that are behind the IRD switched. That is, the reporting does not need be granular to the individual subscriber level.

At step 708 of the method 700, one or more ACS data structures (e.g., records) are received. For example, in one embodiment, the client device 106 may utilize an interface to push content switch records to the server apparatus 202. See FIG. 4 for an example of an ACS record 400.

Additionally, the client device 106 may provide a log file of all content switches from the primary content to the alternate content, including the channel number, the time of the switch, the source information, etc. In this embodiment, the log file may include a running log of all the switches in a format containing a pre-switch configuration of the primary content and a post-switch configuration of the primary content, the state of the alternate content both pre-switch and post-switch, and both the primary content and the alternate content pre and post-switch time stamped with a resolution of at least 0.1 seconds.

Alternatively, in the instance that ACS event failed or was not validated, that failure or non-validation may be recorded as well. The client device's 106 records may also include SNMP traps for failed switches. For example, if an alternate content switch fails, the server 202 may transmit an error and instruction message to the client 106 which enact appropriate corrections, such as reverting to a “slate” (or black) screen. The slate screen may be displayed purposefully and/or upon a network error. For example, the slate screen may be displayed when the server 202 and/or another server in the network 200 fails to provide the client device 106 with the appropriate alternate content. In this instance, the display may generate a slate static content (e.g., a black screen), and/or a message (i.e., a notification for the reason why an error occurred). The record would indicate that slate screen and/or message was displayed and the ACS event was invalid.

At step 710, a composite data stream is transmitted to a blockchain server. In one embodiment, the composite data stream may include both the verification data and received record(s). In another embodiment, the composite data stream may include just records or verification data from multiple users.

FIG. 7 continues per step 712, where the blockchain server receives the composite data, which in one implementation may be received as a stream. At step 714, the verification data and/or record(s) are hashed, as described above. For instance, the blockchain server 206 may perform a hash algorithm (such as SHA-256) on a plurality of records and verification data in order to generate a root hash (which, if using SHA-256, would be 256 characters long). That is, a hash would be generated for each individual record and each piece of verification data (such as a video capture), and then two of those hashes would be combined to generate an intermediary hash, and then two intermediary hashes would be combined to generate another intermediary, and so on, until a root hash of the predetermined length of characters is reached. The root hash may be combined with a root hash of a previous block to generate a block hash.

At step 716, the hashes (e.g., block hash) are utilized to form blocks and chains. That is, the blockchain server 206 collates the composite data into blocks (see FIG. 5), and chains (see FIG. 6). Once the block is validated, it is added to the blockchain, as described above.

At step 718, the blockchain ledger may be stored. In one embodiment, the blockchain server 206 may store the blockchain ledger in a database 208 of the network 200.

At step 720, the ACS verification data (e.g., hash) may be reported. For example, in one embodiment, for each ACS policy implementation, the program source 204 will receive sample data, examples of which are shown in Table 1 below.

TABLE 1

| ACS Policy | | Proof of |
|---|---|---|
| example | ACS Execution Results | Validation |
| Emmy Awards | Mobile devices that tuned into Channel | Hash # |
| (7-9 PM) viewership | 123 during 7-9 PM = | |
| to be limited for in- | 99% of devices were content restricted | |
| home devices | (ACS success rate = 99%) | |
| 4K content to be | Devices running older iOS that were | Hash # |
| blocked on iOS-7 | tuned into 4K content, during the last | |
| or earlier versions | 30-day period | |

The content provider or program source 204 shall consider the “hash value” as sufficient proof of ACS. The hash is also provided in lieu of receiving a large number of individual customer data. For example, the reported data may simply include “we have achieved 99% compliance, and here is the root hash # as proof” The actual customer data would only need to be revealed/reviewed in an audit session (conducted jointly by program source/distributor 204 in a controlled environment).

FIG. 7a is a graphical representation of one exemplary implementation 750 of the method of FIG. 7, shown as steps 1-8 therein.

### Exemplary Dynamic Secondary Content Operation

Referring now to FIG. 8, an exemplary embodiment of a method 800 for verifying dynamic secondary content events utilizing a blockchain apparatus within a network, such as the exemplary networks of FIGS. 1-1c, 2, and 3 is provided.

As shown, per step 802, secondary content (and/or data relating thereto) is received. For instance, various information, rules, policies, etc. may be ingested into the network 200 from third party content sources or advertisers 204. In one particular implementation of step 302 of the method 300, an advertiser 204 provides secondary content secondary content to the server apparatus 202 of the network 200 for delivery to individual ones of the client 106. The secondary content may be accessed from a secondary content store (not shown) in one implementation.

In one embodiment, the server apparatus 202 may include or be communicative with an Advertisement Management Service (AMS), which is configured to select individual ones of a plurality of secondary content for delivery to individual ones of the client 106. The AMS may, in one embodiment, comprise a server or other computerized device adapted to comply with the requirements set forth in the Society of Cable Telecommunications Engineers SCTE 130-1 and SCTE 130-3 Digital Program Insertion—Advertising Systems Interfaces standards, and/or IAB (Interactive Advertising Bureau) standards and practices, including e.g., those set forth in “Traffic Fraud: Best Practices for Reducing Risk to Exposure”, updated May 2015; “OpenRTB Dynamic Native Ads API—Specification Version 1” dated February 2015; “OpenDirect API Specification Version 1.0”, finalized January 2015; “Digital Video In-Stream Ad Format Guidelines” released Jan. 8, 2016; “RTB Project OpenRTB API Specification Version 2.4” (Final Draft) dated March 2016; and “RTB Project OpenRTB Dynamic Native Ads API, Specification Version 1.1” dated March 2016, each of the foregoing incorporated herein by reference in its entirety. In one embodiment, the AMS may be in data communication with an Advertisement Decisioning Service (ADS). The ADS is a computerized network entity which is adapted to determine individual ones of the plurality of secondary content from the content store (not shown) to be inserted into the primary content and delivered to the client 106, based on e.g., selection applications or algorithms running on the ADS (see FIG. 2).

In another embodiment, step 802 may include a receiver/decoder entity receiving content (e.g., audio, video, data, files, etc.) which is then encoded at the encoder/transcoder to an appropriate format (codec, bitrate, etc.) for the requesting device 106. In one implementation, video is transcoded from a mezzanine quality down to e.g., MPEG-4 or HEVC. The encoder/transcoder may also be used to transcode the content to MP4 in MPEG-2 transport stream (TS) format in a non-rate adaptive manner. The non-rate adaptive format may be used in this case because the stream has a constant bit rate (CBR) at this stage. Utilization of the MPEG-2 TS container enables the MP4 or other content to be multicast to a plurality of devices on the network. Additionally, the MPEG-2 TS content may be delivered with advertisement or other “secondary” content inserted therein via one or more intermediary advertisement insertion mechanisms (not shown). Exemplary apparatus and methods for selection of secondary content to be inserted (e.g., via a “targeted” approach) are described in co-owned U.S. patent application Ser. No. 11/186,452 filed on Jul. 20, 2005 and entitled “Method And Apparatus For Boundary-Based Network Operation,” U.S. Pat. No. 9,071,859 issued on Jun. 30, 2015 and entitled “Methods And Apparatus For User-Based Targeted Content Delivery,” and U.S. patent application Ser. No. 12/766,433 filed on Apr. 23, 2010 and entitled “Apparatus And Methods For Dynamic Secondary Content And Data Insertion And Delivery,” each of which is incorporated herein by reference in its entirety, although other approaches may be used consistent with the present disclosure.

In one embodiment, the method 800 of FIG. 8 may utilize the exemplary apparatus and methods set forth in co-owned and co-pending U.S. patent application Ser. No. 15/135,186 filed on Apr. 21, 2016 and entitled “Methods and Apparatus for Secondary Content Management and Fraud Prevention,” which is incorporated herein by reference in its entirety. As described therein, in one embodiment, a unique identifier (e.g., session ID, such as a globally unique ID or GUID, or identifier which is unique for each particular client device or process) is generated for inclusion with a manifest file relating to delivery of primary content (e.g., video assets) requested by the user. As detailed therein, this approach allows the architecture (including AMS via ADS) to prevent false “counts” for secondary content (e.g., advertisements) which are associated with the primary content assets, such as might be instigated by a “bot” or other malicious entity.

In one exemplary implementation of the foregoing architecture, one or more “beacons” or indicators (including, without limitation, advertisement tags, web beacons, and metadata or data containers) are also embedded into e.g., the metadata of the secondary content, the secondary content itself, or associated with the URLs of the secondary content (as described in greater detail below). In one embodiment, the one or more beacons or indicators may comprise quartile beacons, indicating that 25%, 50%, and 75% (and 100% if desired) of the individual one of the secondary content has been “consumed” by the client device that is rendering the content. It will be appreciated that the term “consumed” as used in the present context may have various definitions, including without limitation: (i) receipt of a valid consumption request at the AMS 218; (ii) receipt of a data indicative of an actual decode of the relevant chunk(s), or (iii) receipt of data indicative of extraction of the beacon/indicator from e.g., the metadata of a received content chunk (without knowledge of actual decode by the client). In one implementation, the one or more beacons may comprise ID3 tags, such as for example as those adapted to comply with the requirements set forth in ID3 tag version 2.3.0 (see e.g., http://id3.org/id3v2.3.0), which is incorporated herein by reference in its entirety. Alternatively, another mechanism to carry or entrain metadata within an ABR streaming protocol can be used, such as without limitation an encoder-agnostic approach such as MPEG-DASH (aka Dynamic Adaptive Streaming over HTTP); see e.g., ISO/IEC Std. 23009-1:2012 published April, 2012, and incorporated herein by reference in its entirety. The embedding functions may be performed by a encoder/transcoder in one embodiment, although depending on the scheme used, such “embedding” may be performed by other entities (such as where the tag or indicator is part of e.g., a URL or other data element other than the encoded content).

In one embodiment, the triggers or markers contained in the primary content mark an event that is of interest, such as the aforementioned SCTE-35 cues. In one exemplary implementation, the SCTE-35 cues are transported in a binary structure in a MPEG-2 transport stream, and are converted to an ASCII- or XML-based structure and embedded in the manifest file which later can trigger the secondary content (e.g., advertisement) insertion.

At step 804, display of the secondary content on the client device(s) is caused. For instance, in one embodiment, during playback of the requested primary content according to the playlist or manifest thereof, the client 106 may reach a trigger (such as a URL redirect trigger which is placed in a manifest at each instance of an SCTE-35 marker by the packager), indicating that content may no longer be provided, and/or secondary content is needed. The trigger event in one exemplary implementation causes the client device 106 to request the appropriate content (e.g., an appropriate URL) from the server apparatus 202 or another computerized network entity (which may be a software application or process operating on a host server (not shown) or other hardware environment; e.g., co-located with other network functionality). The server apparatus 202 (or other computerized network entity) then selects the appropriate secondary content and delivers it to the client device 106 for rendering thereon.

At step 806, verification data is obtained or collected. In some embodiments, the verification data (e.g., audio, video, and/or text data) is obtained by the server apparatus 202 from the client device(s) 106 via any push/pull mechanisms, as described above. In some variants, video capture capability and/or optical character recognition (OCR) with image comparison capabilities may be provided at the client device 106. The OCR and image comparison capability enables the client device 106 to verify images and text which appear for display at the client device 106. For example, in one variant, in order to validate that the secondary content display did in fact occur, the server apparatus 202 may transmit a data message, composite video signal, or other communication to the client device 106. The client device 106 uses the message to determine whether the secondary content display event did occur, such as by recognizing text within the secondary content, and/or comparing the image of the secondary content that was displayed by the client device 106 to an image of the secondary content that was transmitted to the client device 106 in the message. In another variant, the video capture capability enables the client device 106 to capture video (and/or audio) of the actual display of the secondary content.

At step 808, one or more secondary content display data structures (e.g., records) are received. For example, in one embodiment, the client device 106 may utilize an interface to push content switch records to an server apparatus 202 and may provide a log file of all content secondary content displays and/or viewings. Alternatively, in the instance that the secondary content was not display or the viewing/display thereof was not validated, that non-display or non-validation may be recorded as well.

In one embodiment, as the received secondary content is rendered by the client, the beacons or tags may be extracted from the metadata (or the content elements themselves). Each extracted tag (or information derived therefrom) may then be sent to the server 202 per step 808. It will be appreciated that various orders of performance of the foregoing steps are contemplated by the present disclosure, such as where e.g., (i) the extracted tags or beacons are sent to the server 202 prior to rendering of the (encoded) secondary content element; (ii) the extracted tags or beacons are sent to the server 202 during rendering of the secondary content element; and (iii) the extracted tags or beacons are sent to the server 202 after completion of rendering of the secondary content element, such as by way of the subsequent secondary content element request to the source URL, or as a separate communication. The individual tags/beacons may also be aggregated and sent to the server 202 or other responsible network entity as a file (e.g., record) or similar, such as via an OOB message protocol.

It will be appreciated that various implementations described herein may also dictate varying client device configuration (e.g., in terms of application or other software or middleware) in order to accommodate the verification and/or consumption management functions described herein. For instance, certain embodiments of the client device 106 may be IP-enabled client devices (whether fixed or mobile in form), that may include an MSO or third party “app” thereon for interface with the MSO's IP-packetized content delivery service. The app may, for example, include the necessary code to examine and extract the aforementioned beacons from a manifest file, and utilize them in forming requests to the server 202 or CDN for content delivery, or for informational purposes to the server 202 (e.g., messages indicate of beacons for percent completion).

In other implementations, the client 106 may comprise a DSTB (digital settop box) or the like, with middleware which can be “flashed” or updated in order to implement the beacon functionality. Myriad other configurations of CPE 106 useful with the present disclosure will be recognized by those of ordinary skill.

At step 810, a composite data stream is transmitted to a blockchain server. In one embodiment, the composite data stream may include both the verification data and received record(s). In another embodiment, the composite data stream may include just records or verification data from multiple users.

FIG. 8 continues per step 812, where the blockchain server receives the composite data stream. At step 814, the verification data and/or record(s) are hashed. For instance, the blockchain server 206 may perform a hash algorithm (such as SHA-256) on a plurality of records and verification data in order to generate a root hash (which, if using SHA-256, would be 256 characters long). That is, a hash would be generated for each individual record and each piece of verification data (such as a video capture), and then two of those hashes would be combined to generate an intermediary hash, and then two intermediary hashes would be combined to generate another intermediary, as so on, until a root hash of the predetermined length of characters is reached. The block hash may then be computed by performing a hash function on the root hash of the current block and the root hash of the previous block.

At step 816, the hashes (including root or block hash) are utilized to form blocks and chains. That is, the blockchain server 206 collates the composite data into blocks (see FIG. 5), and chains (see FIG. 6).

At step 818, the blockchain ledger may be stored. In one embodiment, the blockchain server 206 may store the blockchain ledger in a database 208 of the network 200.

At step 820, the display verification data (e.g., hash) may be reported. The content provider or program source 204 shall consider the “hash value” as sufficient proof of secondary content display. The actual customer data would only need to be revealed/reviewed in an audit session (conducted jointly by advertiser/distributor 204 in a controlled environment). FIG. 8a is a graphical representation of one exemplary implementation 850 of the method of FIG. 8, shown as steps 1-8 therein.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

It will be appreciated that while certain steps and aspects of the various methods and apparatus described herein may be performed by a human being, the disclosed computer technology improvements are computer-implemented, and computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A computerized method for verifying an event in a content delivery network, the computerized method comprising:
receiving first data;
applying the first data to one or more computerized devices, the applying configured to cause the event;
based on a verification of an occurrence of the event, receiving at least one data structure associated with the event and verification data relating to the verification;
causing generation of a cryptographic hash of the at least data structure and verification data;
causing application of the cryptographic hash to a ledger; and
causing storage of the ledger in a database.

2. The computerized method of claim 1, wherein the receiving of the first data comprises receiving alternate content switching (ACS) data, and the event comprises an ACS-related event.

3. The computerized method of claim 2, wherein the receiving of the ACS data comprises receiving the ACS data from one or more program sources.

4. The computerized method of claim 3, further comprising enabling access to ACS validation data to at least one of the one or more program sources, the ACS validation data comprising the cryptographic hash, the cryptographic hash serving as proof of the AC S-related event.

5. The computerized method of claim 4, further comprising enabling an interface for the enabling of the access to the at least one of the one or more program sources, or a proxy thereof, wherein the interface is based on public/private key encryption (PKE).

6. The computerized method of claim 1, wherein the applying of the first data comprises transmitting the first data to at least one of: (i) customer premises equipment (CPE), and (ii) one or more computerized mobile devices.

7. The computerized method of claim 1, wherein the applying of the first data comprises transmitting the first data to one or more computerized test devices located in a video operations data center.

8. The computerized method of claim 1, further comprising causing verification of the occurrence of the event;
wherein the verification comprises an operator manually causing the verification of the occurrence of the event by use of visual data.

9. The computerized method of claim 1, further comprising causing verification of the occurrence of the event;
wherein the verification comprises automatically verifying the occurrence of the event by use of a computerized automated process based at least on one or more machine learning or artificial intelligence algorithms.

10. The computerized method of claim 1, wherein:
the receiving of the data structure of the event comprises receiving a record, the record comprising at least data indicative of the event; and
the verification data comprises metadata created during the event, the metadata comprising data representative of a video capture of the event.

11. The computerized method of claim 1, wherein the receiving of the verification data comprises utilizing a push or pull mechanism.

12. The computerized method of claim 1, further comprising transmitting the data structure to a blockchain-based server apparatus;
wherein the blockchain-based server apparatus is configured to perform the generation, the application, and the storage.

13. The computerized method of claim 12, wherein the transmitting comprises streaming at least a portion of the first data to the blockchain-based server apparatus.

14. The computerized method of claim 1, wherein the causing of the application of the cryptographic hash to the ledger comprises causing creation of a data block and formation of a chain by use of the data block with one or more other data blocks.

15. A non-transitory computer readable apparatus having a storage medium, the storage medium comprising at least one computer program having a plurality of instructions, the plurality of instructions configured to, when executed, cause verification of digital secondary content servicing in a content delivery network using at least the computerized method comprising:
receiving digital secondary content from one or more sources of the content delivery network;
causing display of the digital secondary content on one or more computerized devices;
receiving a data structure associated with the display event;
causing generation of a cryptographic hash, the cryptographic hash comprising a hash of at least the data structure;
causing formation of a blockchain data structure via use of the cryptographic hash; and
causing storage of the blockchain data structure in a database.

16. The non-transitory computer readable apparatus of claim 15, wherein the receiving of the digital secondary content comprises receiving an advertisement, and the one or more sources comprise one or more respective advertisers.

17. The non-transitory computer readable apparatus of claim 15, wherein the causing of the display of the digital secondary content on the one or more computerized devices comprises causing display of the digital secondary content on at least one of: (i) customer premises equipment (CPE), (ii) one or more computerized mobile devices, (iii) one or more computerized test devices, the one or more computerized test devices located in a video operations data center, and (iv) a virtual machine environment.

18. The non-transitory computer readable apparatus of claim 15, wherein the receiving of the data structure associated with the display event comprises receiving a record of a display of only a portion of the digital secondary content, the portion determined based on use of a percentile beacon.

19. The non-transitory computer readable apparatus of claim 15, wherein:
the computerized method further comprises:
receiving verification data from the one or more computerized devices, the verification data indicating a verification of the display event; and
transmitting the data structure associated with the display event and the verification data to a blockchain server apparatus together in a composite data stream;
the generation, the formation, and the storage are each performed automatically by the blockchain server based on receipt of the composite data stream; and
the cryptographic hash comprises a hash of at least the data structure and the verification data.

20. A distributed network architecture for verification of one or more events in a network, the distributed network architecture comprising:
a plurality of computerized client devices, the plurality of computerized client devices in data communication with one or more respective intermediary entities;
wherein:
the one or more intermediary entities are (i) in data communication with one or more respective blockchain server apparatus, and (ii) configured to transmit data relating one or more events to the one or more blockchain server apparatus based on an occurrence of the one or more events or on verification of the occurrence of the one or more events; and
the one or more blockchain server apparatus are configured to automatically perform a blockchain process, the blockchain process comprising (i) one or more hash functions performed on the data relating the one or more events, and (ii) validation of the one or more events.
